(19) United States
(12) Patent Application Publication
(10) Pub. No.: US 2026/0271053 A1
(43) Pub. Date: Sep. 10, 2026

(54) REQUEST-BASED PREEMPTION

(71) Applicant: Ofinno, LLC, Reston, VA (US)

(72) Inventors: Leonardo Alisasis Lanante, Reston, VA (US); Jeongki Kim, Fairfax, VA (US); Esmael Hejazi Dinan, McLean, VA (US); Jiayi Zhang, Rockville, MD (US); Serhat Erkucuk, Reston, VA (US); Tuncer Baykas, Reston, VA (US)

(73) Assignee: Ofinno, LLC, Reston, VA (US)

(21) Appl. No.: 19/661,885

(22) Filed: Apr. 29, 2026

Related U.S. Application Data
(63) Continuation of application No. PCT/US2024/054818, filed on Nov. 7, 2024.
(60) Provisional application No. 63/548,018, filed on Nov. 10, 2023.

(51) Int. Cl. H04W 74/00

(52) U.S. Cl. CPC H04W 74/002

(57) ABSTRACT

A first station (STA) receives from a second STA a first physical layer protocol data unit (PPDU) comprising: a field used to determine whether preemption of a second PPDU following the first PPDU is allowed; a first scrambler initial value for descrambling a data field of the first PPDU; and a second scrambler initial value. Based on the field indicating allowance of preemption of the second PPDU, the first STA transmits to the second STA a third PPDU comprising a third scrambler initial value based on the second scrambler initial value.

### CROSS-REFERENCE TO RELATED APPLICATIONS

This application is a continuation of International Application No. PCT/US2024/054818, filed Nov. 7, 2024, which claims the benefit of U.S. Provisional Application No. 63/548,018, filed Nov. 10, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example of a Medium Access Control (MAC) frame format.

FIG. 4 illustrates an example clear to send (CTS) frame format.

FIG. 5 illustrates an example physical layer protocol data unit (PPDU) format.

FIG. 6 illustrates an example non-High Throughput (non-HT) PPDU format.

FIG. 7 illustrates an example service field.

FIG. 8 illustrates an example data scrambler/descrambler.

FIG. 9 illustrates an example multi-user request to send (MU-RTS) trigger frame format.

FIG. 10 illustrates an example common info field.

FIG. 11 is an example that illustrates an MU-RTS/CTS procedure.

FIG. 12 is an example that illustrates an uplink preemption procedure.

FIG. 13 is an example that illustrates a downlink preemption procedure.

FIG. 14 is an example that illustrates an uplink preemption procedure using a preemption request.

FIG. 15 is another example that illustrates an uplink preemption procedure using a preemption request.

FIG. 16 is an example that illustrates a problem that may arise in the uplink preemption procedure of FIG. 14.

FIG. 17 is an example that illustrates an uplink preemption procedure according to an embodiment.

FIG. 18 is an example that illustrates another uplink preemption procedure according to an embodiment.

FIG. 19 is an example that illustrates another uplink preemption procedure according to an embodiment.

FIG. 20 is an example that illustrates another uplink preemption procedure according to an embodiment.

FIG. 21 is an example that illustrates an uplink preemption procedure according to an embodiment.

FIG. 22 is an example that illustrates another uplink preemption procedure according to an embodiment.

FIG. 23 is an example that illustrates another uplink preemption procedure according to an embodiment.

FIG. 24 illustrates an example process according to an embodiment.

FIG. 25 illustrates another example process according to an embodiment.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages are presented for example purposes only. The disclosed architecture is sufficiently flexible and configurable, such that it may be utilized in ways other than those shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g., hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers, and microprocessors are programmed using languages such as assembly, C, C++, or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

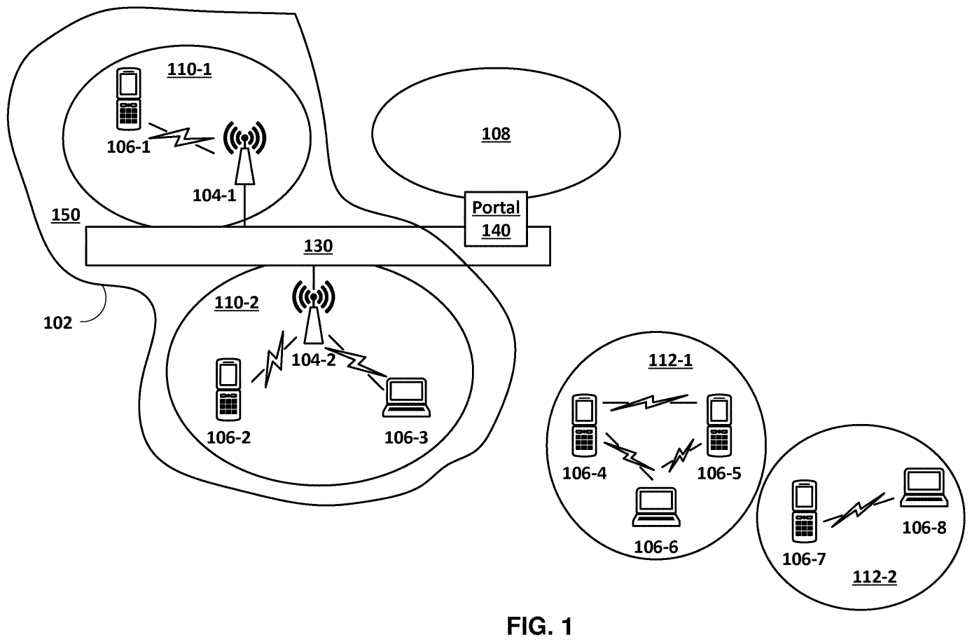

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PHY service data unit (PSDU). For example, the PSDU may include a PHY preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHz, 5 GHz, and/or 6 GHz bands, each of which may be divided into multiple 20 MHz channels. The PPDUs may be transmitted over a physical channel having a minimum bandwidth of 20 MHz. Larger channels may be optionally formed through channel bonding of a primary 20 MHz channel and one or more 20 MHz secondary channels. For example, PPDUs may be transmitted over physical channels having bandwidths of 40 MHz, 80 MHz, 160 MHz, or 320 MHz by bonding together a primary 20 MHz channel and 1, 3, 7, or 15 secondary channel respectively. The primary channel is a common channel operation for all STAs where management frames are sent by the AP to ensure that all STAs (regardless of channel bonding support) can receive.

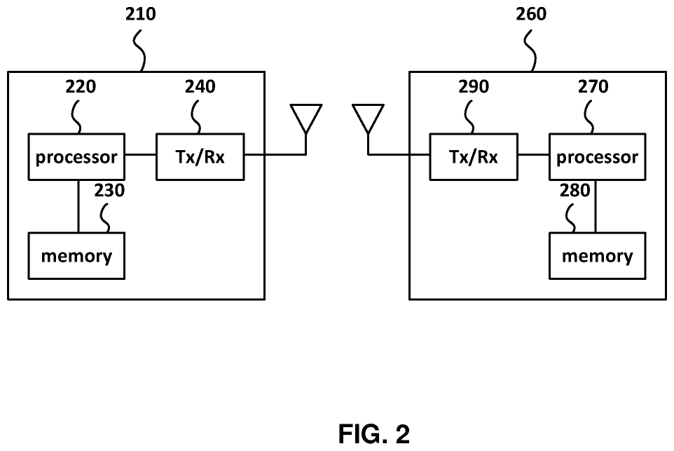

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

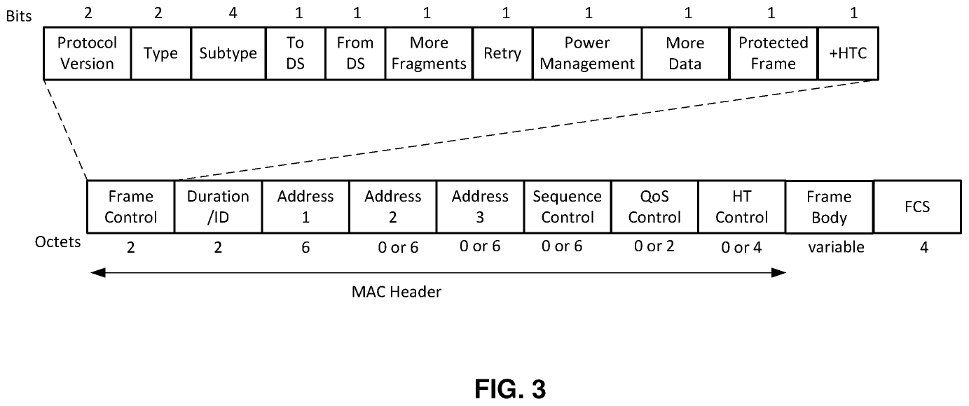

FIG. 3 illustrates an example format of a MAC frame. In operation, a STA may construct a subset of MAC frames for transmission and may decode a subset of received MAC frames upon validation. The particular subsets of frames that a STA may construct and/or decode may be determined by the functions supported by the STA. A STA may validate a received MAC frame using the frame check sequence (FCS) contained in the frame and may interpret certain fields from the MAC headers of all frames.

As shown in FIG. 3, a MAC frame includes a MAC header, a variable length frame body, and a frame check sequence (FCS).

The MAC header includes a frame control field, an optional duration/ID field, address fields, an optional sequence control field, an optional QoS control field, and an optional HT control field.

The frame control field includes the following subfields: protocol version, type, subtype, “To DS”, “From DS”, “More Fragments”, retry, power management, “More Data, protected frame, and +HTC.

The protocol version subfield is invariant in size and placement across all revisions of the IEEE 802.11 standard. The value of the protocol version subfield is 0 for MAC frames.

The type and subtype subfields together identify the function of the MAC frame. There are three frame types: control, data, and management. Each of the frame types has several defined subtypes. Bits within the subtype subfield are used to indicate a specific modification of the basic data frame (subtype 0). For example, in data frames, the most significant bit (MSB) of the subtype subfield, bit 7 (B7) of the frame control field, is defined as the QoS subfield. When the QoS subfield is set to 1, it indicates a QoS data frame, which is a data frame that contains a QoS control field in its MAC header. The second MSB of the subtype field, bit 6 (B6) of the frame control field, when set to 1 in data subtypes, indicates a data frame that contain no frame body field.

The “To DS” subfield indicates whether a data frame is destined to the distribution system (DS). The “From DS” subfield indicates whether a data frame originates from the DS.

The “More Fragments” subfield is set to 1 in all data or management frames that have another fragment to follow the MAC service data unit (MSDU) or MAC management protocol data unit (MMPDU) carried by the MAC frame. The “More Fragments” subfield is set to 0 in all other frames in which the “More Fragments” subfield is present.

The retry subfield is set to 1 in any data or management frame that is a retransmission of an earlier frame. It is set to 0 in all other frames in which the retry subfield is present. A receiving STA uses this indication to aid it in the process of eliminating duplicate frames. These rules do not apply for frames sent by a STA under a block agreement.

The power management subfield is used to indicate the power management mode of a STA.

The “More Data” subfield indicates to a STA in power save (PS) mode that bufferable units (BUs) are buffered for that STA at the AP. The “More Data” subfield is valid in individually addressed data or management frames transmitted by an AP to a STA in PS mode. The “More Data” subfield is set to 1 to indicate that at least one additional buffered BU is present for the STA.

The protected frame subfield is set to 1 if the frame body field contains information that has been processed by a cryptographic encapsulation algorithm.

The +HTC subfield indicates that the MAC frame contains an HT control field.

The duration/ID field of the MAC header indicates various contents depending on the frame type and subtype and the QoS capabilities of the sending STA. For example, in control frames of the power save poll (PS-Poll) subtype, the duration/ID field carries an association identifier (AID) of the STA that transmitted the frame in the 14 least significant bits (LSB), with the 2 most significant bits (MSB) set to 1. In other frames sent by STAs, the duration/ID field contains a duration value (in microseconds) which is used by a recipient to update a network allocation vector (NAV). The NAV is a counter that indicates to a STA an amount of time during which the STA must defer from accessing the shared medium.

Up to four address fields may be present in the MAC frame format. The address fields are used to indicate the basic service set identifier (BSSID), source address (SA), destination address (DA), transmitting address (TA), and receiving address (RA). Certain frames may not contain some of the address fields. Certain address field usage may be specified by the relative position of the address field (1-4) within the MAC header, independent of the type of address present in that field. Specifically, the address 1 field always identifies the intended receiver(s) of the frame, and the address 2 field, where present, always identifies the transmitter of the frame.

The sequence control field includes two subfields, a sequence number subfield and a fragment number subfield. The sequence number subfield in data frames indicates the sequence number of the MSDU (if not in an Aggregated MSDU (A-MSDU)) or A-MSDU. The sequence number subfield in management frames indicates the sequence number of the frame. The fragment number subfield indicates the number of each fragment of an MSDU or MMPDU. The fragment number is set to 0 in the first or only fragment of an MSDU or MMPDU and is incremented by one for each successive fragment of that MSDU or MMPDU. The fragment number is set to 0 in a MAC protocol data unit (MPDU) containing an A-MSDU, or in an MPDU containing an MSDU or MMPDU that is not fragmented. The fragment number remains constant in all retransmissions of the fragment.

The QoS control field identifies the traffic category (TC) or traffic stream (TS) to which the MAC frame belongs. The QoS control field may also indicate various other QoS related, A-MSDU related, and mesh-related information about the frame. This information can vary by frame type, frame subtype, and type of transmitting STA. The QoS control field is present in all data frames in which the QoS subfield of the subtype subfield is equal to 1.

The HT control field is present in QoS data, QoS null, and management frames as determined by the +HTC subfield of the frame control field.

The frame body field is a variable length field that contains information specific to individual frame types and subtypes. The frame body may include one or more MSDUs or MMPDUs. The minimum length of the frame body is 0 octets.

The FCS field contains a 32-bit Cyclic Redundancy Check (CRC) code. The FCS field value is calculated over all of the fields of the MAC header and the frame body field.

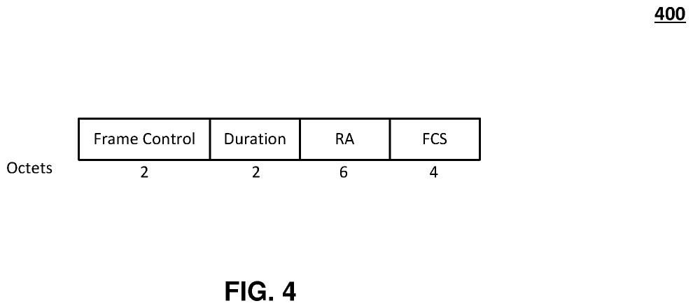

FIG. 4 illustrates an example clear to send (CTS) frame format. As shown in FIG. 4, the CTS frame format may comprise a Frame Control field, a Duration field, an RA field, and an FCS field. The Frame Control field may be similar to the Frame Control field described in FIG. 3 above.

If the CTS frame is a response to a request to send (RTS) frame, the RA field of the CTS frame is set to the address from the TA field of the RTS frame with the Individual/Group bit set to 0. If the CTS frame is the first frame in a frame exchange, the RA field is set to the MAC address of the transmitter. If the CTS frame is a response to an MU-RTS Trigger frame, the RA field of the CTS frame is set to the address from the TA field of the MU-RTS Trigger frame.

For all CTS frames transmitted by a non-QoS STA in response to RTS frames, the Duration field is the value obtained from the Duration field of the immediately previous RTS frame, minus the time, in microseconds, required to transmit the CTS frame and its SIFS. If the calculated duration includes a fractional microsecond, that value is rounded up to the next higher integer.

At a non-QoS STA, if the CTS frame is the first frame in the exchange and the pending Data or Management frame requires acknowledgment, the Duration field is the time, in microseconds, required to transmit the pending Data or Management frame, plus two SIFSs plus one Ack frame. At a non-QoS STA, if the CTS frame is the first frame in the exchange and the pending Data or Management frame does not require immediate acknowledgment, the Duration field is the time, in microseconds, required to transmit the pending Data or Management frame, plus one SIFS. If the calculated duration includes a fractional microsecond, that value is rounded up to the next higher integer.

For other CTS frame transmissions by a QoS STA, the Duration field is set as defined in section 9.2.5 (Duration/ID field (QoS STA)) of the IEEE 802.11 standard (“IEEE P802.11-REVme™/D4.1, October 2023”).

A CTS-to-self frame is a CTS frame in which the RA field is equal to the transmitter's MAC address. A CTS-to-AP frame is a CTS frame that is not transmitted in response to an RTS frame and in which the RA field is equal to the MAC address of the AP with which the STA is associated.

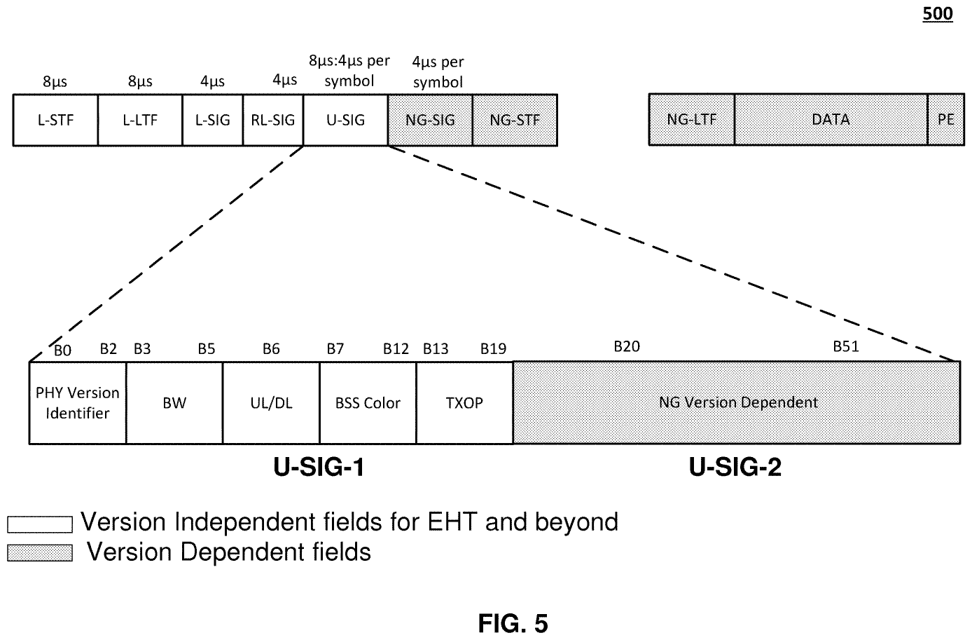

FIG. 5 illustrates an example PPDU format 500. Example PPDU format 500 may be defined in a post-EHT (Extremely High Throughput) PHY (hereinafter referred to as Next Generation (NG) PHY). As shown in FIG. 5, example PPDU format 500 includes a legacy short training field (L-STF), a legacy long training field (L-LTF), a legacy signal field (L-SIG), a repeated L-SIG (RL-SIG), a universal signal field (U-SIG), an NG signal field (NG-SIG), an NG short training field (NG-STF), an NG long training field (NG-LTF), a data field, and a packet extension (PE) field. The fields from the L-STF up to the NG-SIG are version independent fields. They are thus backward compatible to the EHT PHY. The fields from NG-SIG up to the PE field may or may not be backward compatible to the EHT PHY. In order to differentiate PPDU format 500 as an NG PPDU, a PHY Version Identifier field of the U-SIG may be set to a different value than that used for an EHT PPDU.

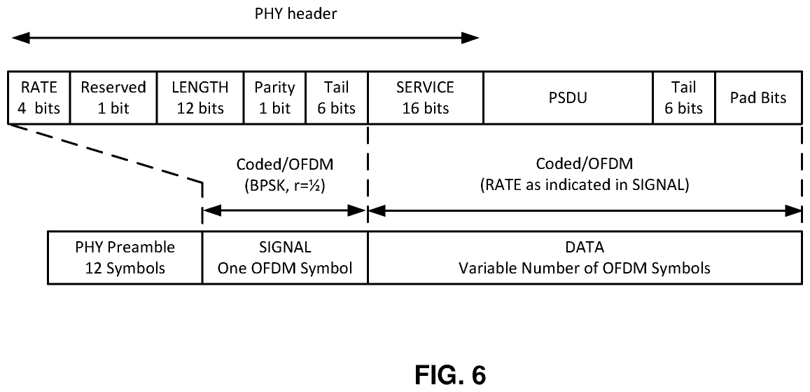

FIG. 6 illustrates an example PPDU format that shows the OFDM symbol composition of a PPDU. As shown in FIG. 6, the PPDU may include a PHY preamble, a PHY header, a PSDU, tail bits, and pad bits. The PHY preamble may include 12 OFDM symbols.

The PHY header includes a SIGNAL field and a SERVICE field. The SIGNAL field includes a RATE field, a reserved bit, a LENGTH field, a parity bit, and tail bits. The tail bits of the SIGNAL field enable decoding of the RATE and LENGTH fields immediately after the reception of the tail bits. The SIGNAL field may constitute a single OFDM symbol. The SIGNAL field may be transmitted using the most robust combination of Binary Phase Shift Keying (BPSK) modulation and a coding rate of R=½.

The SERVICE field of the PHY header and the PSDU (with 6 zero tail bits and pad bits appended), denoted as DATA field, are transmitted at the data rate described in the RATE field of the PHY header. The DATA field may constitute multiple OFDM symbols. The RATE and LENGTH fields are required for decoding the DATA field.

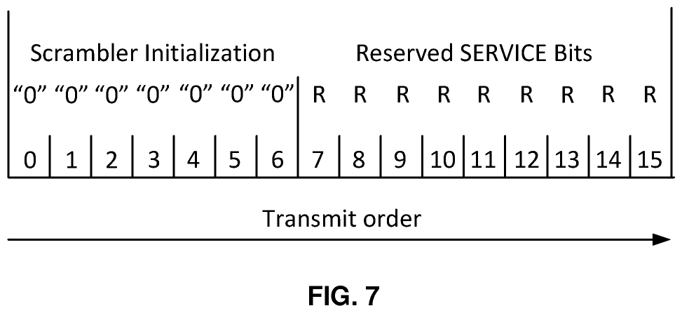

FIG. 7 illustrates an example format of the SERVICE field of a PPDU. As shown, the SERVICE field may include 16 bits, denoted as bits 0-15. Bit 0 is transmitted first in time and bit 15 is transmitted last in time. Bits 0-6 are set to 0s and are used to synchronize the descrambler in the receiver. The remaining 9 bits (bits 7-15) are reserved for future use. Reserved bits are set to 0 on transmission and are ignored by the receiver.

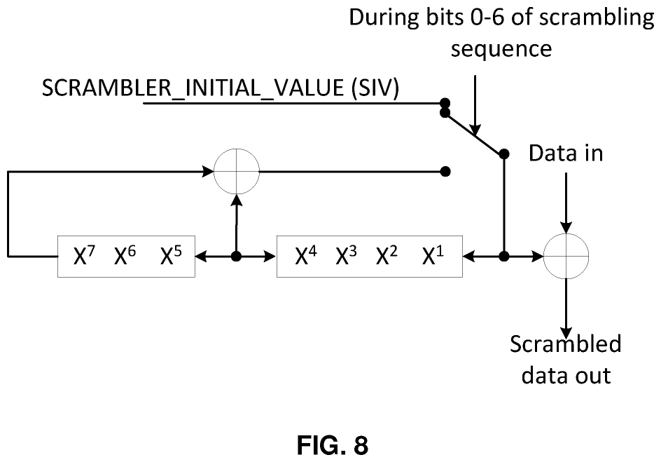

FIG. 8 illustrates an example data scrambler/descrambler. The example data scrambler/descrambler may be used to scramble or descramble the DATA field of a PPDU. As mentioned above, the DATA field may comprise the SERVICE field, the PSDU, and the 6 tail bits and pad bits appended to the PSDU. As shown in FIG. 8, the scrambling process allows the scrambling/descrambling of the DATA field with a scrambler/descrambler that implements the generator polynomial S(x)=x⁷+x⁴+1. In an implementation, the scrambler may be initialized using a SCRAMBLER_INITIAL_VALUE (SIV) to generate a scrambling/descrambling sequence. This may be the case when the “SCRAMBLER_INITIAL_VALUE is present” condition is true. According to the IEEE 802.11 standard, this condition is true for PPDUs carrying an MU-RTS Trigger frame and PPDUs carrying a CTS frame in response to an MU-RTS Trigger frame. For PPDU transmission, the SIV is a TXVECTOR parameter (an integer in the range 1-127) used as the first 7 bits of the scrambling sequence. A PHY layer of a STA upon receiving the SIV from the MAC layer may configure its scrambler such that the first 7 bits of the scrambling sequence for the PPDU are equal to the SIV (e.g., as shown in FIG. 8). Note that due to the first 7 bits of the DATA field (which correspond to the first 7 bits of the SERVICE field) being all zero before scrambling, scrambling the DATA field with the scrambling sequence results in the first 7 bits of the scrambled DATA field (which also correspond to the first 7 bits of the SERVICE field after scrambling) being equal to the SIV (because the scrambler performs an XOR operation). For PPDU reception, the SIV is an RXVECTOR parameter and may be generated as the value of the first 7 bits of the SERVICE field prior to descrambling. In this disclosure, the first 7 bits of the SERVICE field after scrambling are referred to as the SIV part of the SERVICE FIELD.

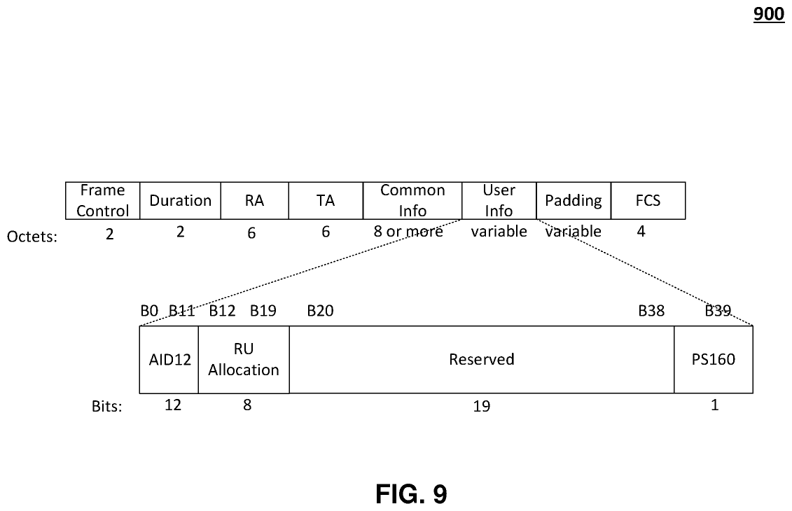

FIG. 9 illustrates an example multi-user request to send (MU-RTS) trigger frame 900. MU-RTS trigger frame 900 may be used by an AP to solicit simultaneous CTS frames from multiple STAs to transmit a downlink (DL) MU PPDU to the multiple STAs. As shown in FIG. 5, MU-RTS trigger frame 900 may comprise a frame control field, a duration field, an RA field, a TA field, a common info field, one or more user info fields, a padding field, and an FCS field. The duration field may be set to the time, in microseconds, required to transmit the DL MU PPDU, plus the time required to transmit one CTS frame, one ACK frame (if required), and three SIFS periods.

The one or more user info fields correspond respectively to the one or more STAs solicited by MU-RTS trigger frame 900. As shown in FIG. 9, a user info field may comprise an AID12 subfield, an RU allocation subfield, reserved bits, and a PS 160 subfield. The AID12 subfield comprises an association identifier of the STA to which the user info field is addressed. The RU allocation subfield indicates a channel on which the solicited STA is to transmit the CTS frame. In an example, this may include a primary 20 MHz channel, a primary 40 MHz, a primary 80 MHz channel, a primary 160 MHz, an 80+80 Mhz channel, or a 320 MHz channel.

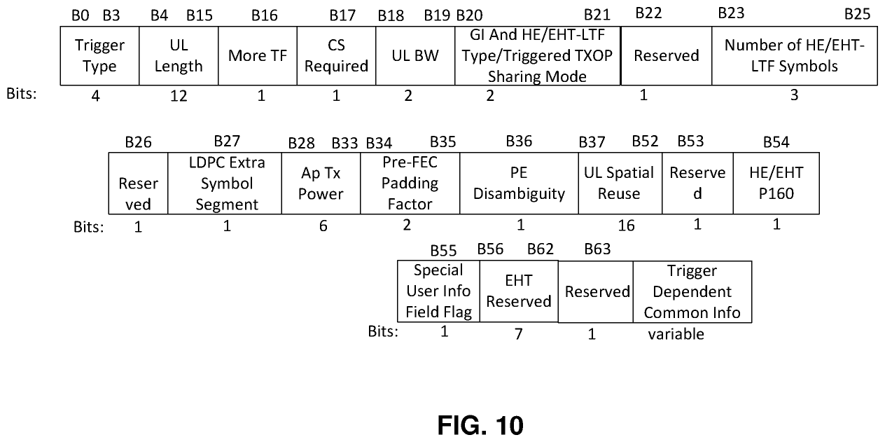

FIG. 10 illustrates an example common info field 1000. Common info field 1000 may be an embodiment of the common info field of MU-RTS trigger frame 900, for example. As shown in FIG. 10, common info field 1000 may include a Trigger Type subfield, a UL Length subfield, a More TF subfield, a CS required subfield, a UL BW subfield, a GI and HE/EHT-LTF Type/Triggered TXS Mode subfield, a first Reserved subfield, a Number of HE/EHT-LTF Symbols subfield, a second Reserved subfield, an LDPC Extra Symbol Segment subfield, an AP Tx Power subfield, a Pre-FEC Padding Factor subfield, a PE Disambiguity subfield, an UL Spatial Reuse subfield, a third Reserved subfield, an HE/EHT P160 subfield, a Special User Info Field Flag subfield, an EHT Reserved subfield, a fourth Reserved subfield, and a Trigger Dependent Common Info subfield. The Trigger Type subfield, UL Length subfield, More TF subfield, CS required subfield, UL BW subfield, GI and HE-LTF Type/Triggered TXS Mode subfield, first Reserved subfield, Number of HE/EHT-LTF Symbols subfield, second Reserved subfield, LDPC Extra Symbol Segment subfield, AP Tx Power subfield, Pre-FEC Padding Factor subfield, PE Disambiguity subfield, UL Spatial Reuse subfield, third Reserved subfield, HE/EHT P160 subfield, Special User Info Field Flag subfield, EHT Reserved subfield, fourth Reserved subfield, and Trigger Dependent Common Info subfield may have the same content and interpretation as corresponding subfields of an EHT variant Common Info field defined in the IEEE 802.11be draft amendment (“IEEE P802.11be/D3.1, March 2023”).

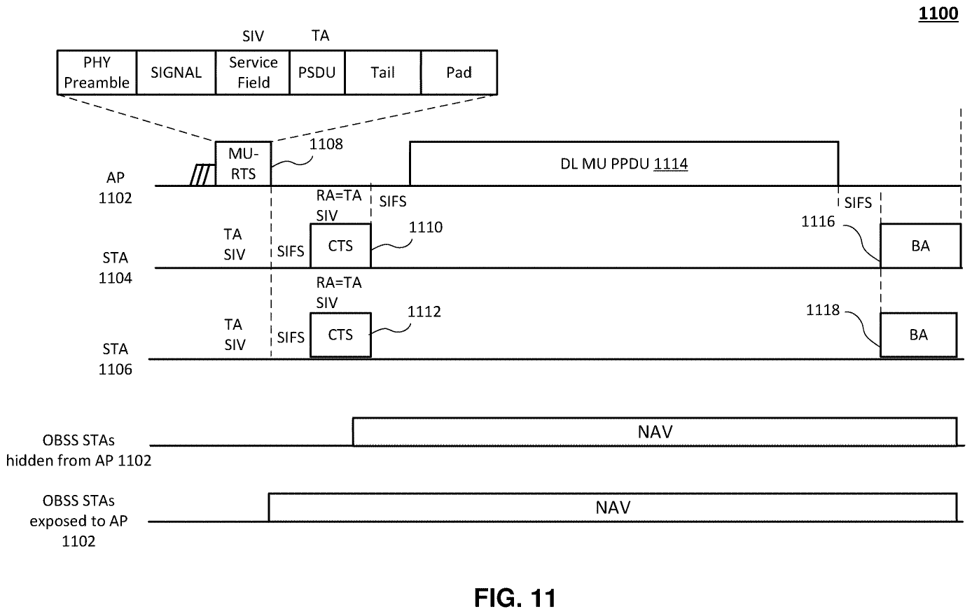

FIG. 11 is an example 1100 that illustrates an MU-RTS/CTS procedure. Example 1100 may be an example according to the MU-RTS/CTS procedure as defined in section 26.2.6 of the IEEE 802.11 standard draft (“IEEE P 802.11-REVme™/D4.1, October 2023”). As shown in FIG. 11, example 1100 may include an AP 1102 and STAs 1104 and 1106. STAs 1104 and 1106 may be associated with AP 1102. For the purpose of illustration, example 1100 also illustrates STAs of an overlapping basic service set (OBSS) relative to the BSS of AP 1102 (OBSS STAs). The OBSS STAs, as shown in FIG. 11, may be hidden from AP 1102 (outside of the communication range of AP 1102) or exposed to AP 1102 (within the communication range of AP 1102).

In example 1100, AP 1102 wishes to transmit a downlink (DL) multi-user (MU) PPDU 1114 to STAs 1104 and 1106. DL MU PPDU 1114 may comprise data for each of STAs 1104 and 1106. DL MU PPDU 1114 may occupy a plurality of channels (e.g., 20 MHz channels). Each channel of the plurality of channels may carry the data for a respective STA (e.g., STA 1104, STA 1106) served by DL MU PPDU 1114.

As shown in FIG. 11, to protect the transmission of DL MU PPDU 1114 to STAs 1104 and 1106 from interference by OBSS STAs hidden from AP 1102, AP 1102 may use the MU-RTS/CTS procedure to initiate a TXOP and to protect the TXOP frame exchange sequence. AP 1102 may initiate the TXOP by transmitting an MU-RTS trigger frame 1108 that solicits simultaneous CTS frame transmissions from STAs 1104 and 1106.

MU-RTS trigger frame 1108 may have a format as illustrated by MU-RTS trigger frame 900 illustrated in FIG. 9. As such, MU-RTS trigger frame 1108 may comprise a frame control field, a duration field, an RA field, a TA field, a common info field, one or more user info fields, a padding field, and an FCS field. The duration field may be set to the time, in microseconds, required to transmit DL MU PPDU 1114, plus the time required to transmit one CTS frame, one ACK frame (if required), and three SIFS periods.

The one or more user info fields correspond respectively to the one or more STAs solicited by the MU-RTS trigger frame. In example 1100, MU-RTS trigger frame 1108 may comprise a user info field for each of STAs 1104 and 1106 indicating that a CTS frame is solicited from each of STAs 1104 and 1106. As shown in FIG. 9, a user info field may comprise an AID12 subfield, an RU allocation subfield, reserved bits, and a PS 160 subfield. The AID12 subfield comprises an association identifier of the STA to which the user info field is addressed. The RU allocation subfield indicates a channel on which the solicited STA is to transmit the CTS frame. In an example, this may include a primary 20 MHz channel, a primary 40 MHz, a primary 80 MHz channel, a primary 160 MHz, an 80+80 Mhz channel, or a 320 MHz channel.

As shown in FIG. 11, AP 1102 may transmit MU-RTS trigger frame 1108 in a PPDU that may comprise a PHY preamble, a SIGNAL field, a SERVICE field, a PSDU, a tail and pad bits. The SERVICE field, PSDU, tail, and pad bits may be scrambled as described above in FIG. 8. MU-RTS trigger frame 1108 may be carried in the PSDU of the PPDU. In an implementation, the PPDU carrying MU-RTS trigger frame 1108 may occupy one or more channels (e.g., 20 MHz channels). In an example, for each channel occupied by the PPDU that carries MU-RTS trigger frame 1108, AP 1102 may request at least one non-AP STA to send a CTS frame that occupies that channel. In an example, AP 1102 may not request that a non-AP STA send a CTS frame that occupies a channel that is not occupied by the PPDU carrying MU-RTS trigger frame 1108.

After transmitting MU-RTS trigger frame 1108, AP 1102 may wait for a CTSTimeout interval of aSIFSTime+aSlotTime+aRxPHYStartDelay that begins when a MAC layer of AP 1102 receives a PHYTXEND. confirm primitive for transmitted MU-RTS trigger frame 1108. If the MAC layer does not receive a PHY-RXEARLYSIG. indication or a PHY-RXSTART. indication primitive during the CTSTimeout interval, AP 1102 may conclude that the transmission of MU-RTS trigger frame 1108 has failed, and, if MU-RTS trigger frame 1108 initiated a TXOP, AP 1102 may invoke its backoff procedure. If the MAC layer receives a PHY-RXEARLYSIG. indication or a PHY-RXSTART. indication primitive during the CTSTimeout interval, then the MAC layer may wait for the corresponding PHY-RXEND. indication primitive to determine whether transmission of MU-RTS trigger frame 1108 was successful. The receipt of a CTS frame from any non-AP STA addressed by MU-RTS trigger frame 1108 before the PHY-RXEND. indication primitive shall be interpreted as the successful transmission of MU-RTS trigger frame 1108, permitting the frame exchange sequence to continue. The receipt of any other type of frame shall be interpreted as a failure of the transmission of MU-RTS trigger frame 1108. AP 1102 may process the received frame and, if MU-RTS trigger frame 1108 initiated a TXOP, AP 1102 shall invoke its backoff procedure at the PHY-RXEND. indication primitive.

In example 1100, on receiving MU-RTS trigger frame 1108, STAs 1104 and 1106 respond by transmitting respectively CTS frames 1110 and 1112 to AP 1102. In an example, STAs 1104 and 1106 begin the transmission of CTS frames 1110 and 1112, respectively, at the SIFS time boundary after an end of a received PPDU comprising MU-RTS trigger frame 1108. In an example, STA 1104 (or STA 1106) responds to MU-RTS trigger frame 1108 with a CTS frame when the following conditions are met: MU-RTS trigger frame 1108 comprises a user info field addressed to the STA (the AID12 subfield of the user info field is equal to the 12 LSBs of the AID of the STA) and MU-RTS trigger frame 1108 is sent by an AP with which the STA is associated; and the uplink (UL) MU carrier sensing (CS) condition indicates that the medium is idle as described in section 26.5.2.5 (UL MU CS mechanism) of the IEEE 802.11 standard (“IEEE P 802.11-REVme™/D4.1, October 2023”). Otherwise, if one of the conditions is not met, STA 1104 (or STA 1106) does not send a CTS frame to AP 1102.

In an example, STAs 1104 and 1106 may set an RA field of respectively CTS frames 1110 and 1112 to a TA obtained from the TA field of MU-RTS trigger frame 1108. In an example, STAs 1104 and 1106 may set a duration field of respectively CTS frames 1110 and 1112 based on the duration field of MU-RTS trigger frame 1108, namely as equal to the value of the duration field of MU-RTS trigger frame 1108, adjusted by subtracting the time required to transmit respectively CTS frames 1110 and 1112 and one SIFS period. In an example, STAs 1104 and 1106 may set/generate a SIV part of a SERVICE field of respective PPDUs (bits 0-6 of the SERVICE field after scrambling the DATA field of the respective PPDUs) carrying CTS frames 1110 and 1112 to be equal to a SIV part of the SERVICE field of the PPDU (bits 0-6 of the SERVICE field of the PPDU before descrambling the DATA field of the PPDU) carrying MU-RTS frame 1108.

OBSS STAs exposed to AP 1102 may receive MU-RTS trigger frame 1108 due to being within the communication range of AP 1102. In an example, as shown in FIG. 11, on receiving MU-RTS trigger frame 1108, OBSS STAs exposed to AP 1102 set their respective NAVs based on the duration field of MU-RTS trigger frame 1108. As such, the OBSS STAs exposed to AP 1102 may not access the wireless medium for the duration of the TXOP initiated by AP 1102.

OBSS STAs hidden from AP 1102 do not receive MU-RTS trigger frame 1108 due to being outside the communication range of AP 1102. However, in an example, as shown in FIG. 11, some of the OBSS STAs hidden from AP 1102 may receive CTS frame 1110 and/or CTS frame 1112 and may set their respective NAVs based on the duration field of CTS frame 1110 and/or CTS frame 1112. As such, some of the OBSS STAs hidden from AP 1102 may also not access the wireless medium for the duration of the TXOP initiated by AP 1102.

On receiving CTS frame 1110 and/or CTS frame 1112, AP 1102 may wait a SIFS period before transmitting DL MU PPDU 1114. On receiving DL MU PPDU 1114, STAs 1104 and 1106 may respond by transmitting respective BlockAck (BA) frames 1116 and 1118 to AP 1102.

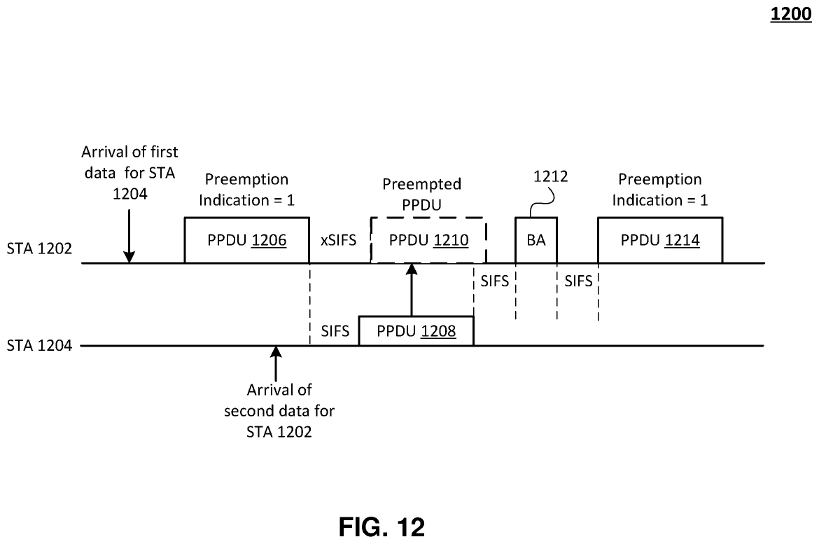

FIG. 12 is an example 1200 that illustrates an uplink preemption procedure. As shown in FIG. 12, example 1200 includes STAs 1202 and 1204. STAs 1202 and 1204 may each be an AP STA or a non-AP STA. For example, STA 1202 may be an AP STA and STA 1204 may be a non-AP STA, or vice versa. In another example, STAs 1202 and 1204 may be both AP STAs or both non-AP STAs.

As shown in FIG. 12, example 1200 begins with the arrival at STA 1202 of first data for transmission to STA 1204. The first data may be non-low latency data. To transmit the first data to STA 1204, STA 1202 may transmit an RTS frame (not shown in FIG. 12) to STA 1204. The RTS frame may indicate a duration of a TXOP to transmit the first data to STA 1204 (and including any intervening interframe spaces and the transmission time of an ACK frame, if required). In an implementation, the first data may be transmitted using multiple PPDUs. In an implementation, the PPDUs may be designed to be shorter than a pre-defined size (e.g., 2 milliseconds). The multiple PPDUs may be configured to be transmitted successively on the wireless medium, separated from one another by an interframe space, xIFS. In an implementation, the interframe space xIFS may be chosen as larger than a short interframe space (SIFS). For example, the interframe space xIFS may be equal to a SIFS plus one or more slot times (a slot time is 9 μs in the 5 GHz band). As such, the duration indicated in the RTS frame may be based on the transmission times of the multiple PPDUs, the intervening interframe spaces, and the transmission time of an ACK frame, if required, from STA 1204. In an implementation, the PPDUs may be configured to include an indication of whether preemption of the PPDUs is allowed. When preemption is allowed, a preempting PPDU may be transmitted in between the multiple PPDUs. Transmission of the remaining PPDUs may resume after transmission of the preempting PPDU. In example 1200, it is assumed that the multiple PPDUs include a preemption indication set to 1 to indicate that preemption of the PPDUs is allowed.

On receiving the RTS frame, and assuming that its NAV indicates idle, STA 1204 may respond to STA 1202 by transmitting a CTS frame (not shown in FIG. 12) to STA 1202. In an implementation, STA 1204 transmits the CTS frame SIFS after receiving the RTS frame. Subsequently, STA 1202 may begin transmitting one or more PPDUs comprising the first data to STA 1204. For example, STA 1202 may transmit a PPDU 1206 comprising a first portion of the first data to STA 1204. In an implementation, STA 1202 may transmit PPDU 1206 an xIFS after receiving the CTS frame from STA 1204.

In example 1200, while STA 1202 transmits PPDU 1206 to STA 1204, STA 1204 may have second data arrive for transmission to STA 1202. In an example, the second data may be low latency data that requires urgent transmission to STA 1202. In an implementation, based on PPDU 1206 comprising a preemption indication set to 1, STA 1204 may begin transmitting a PPDU 1208 comprising the second data a SIFS after receiving PPDU 1206 from STA 1202. In an implementation, as STA 1202 separates successive ones of the multiple PPDUs by an xIFS, STA 1204 begins transmitting PPDU 1208 before STA 1202 may begin transmitting a next PPDU 1210 to STA 1204. PPDU 1208 from STA 1202 to STA 1204 thus preempts PPDU 1210 from STA 1202 to STA 1204. PPDU 1208 may be of the same size, shorter, or longer than PPDU 1210.

In an implementation, STA 1202 may acknowledge PPDU 1208 by transmitting a BA frame 1212 to STA 1204. STA 1202 may then resume transmission of the multiple PPDUs to STA 1204. For example, STA 1202 may transmit a PPDU 1214 comprising a second portion of the first data to STA 1204. In an implementation, STA 1202 may transmit PPDU 1214 an xIFS or a SIFS after transmitting BA frame 1212 to STA 1006. In an example, when PPDU 1214 is the final PPDU of the multiple PPDUs transmitted to STA 1204, STA 1204 may send a BA frame (not shown in FIG. 12) to STA 1202 on receiving PPDU 1214, marking the end of the TXOP.

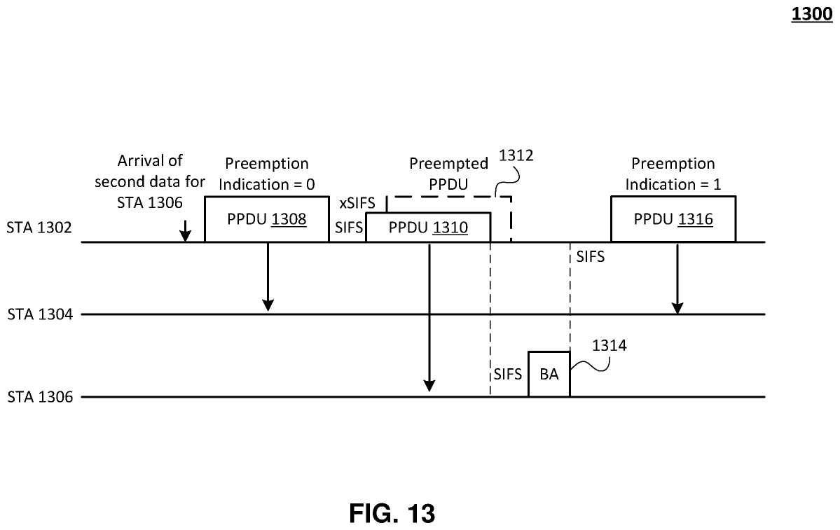

FIG. 13 is an example 1300 that illustrates a downlink preemption procedure. As shown in FIG. 13, example 1300 includes STAs 1302, 1304, and 1306. STAs 1302, 1304, and 1306 may each be an AP STA or a non-AP STA.

As shown in FIG. 13, example 1300 begins with the arrival at STA 1302 of second data for transmission to STA 1306. In an example, the second data may be low latency data that requires urgent transmission to STA 1306. The arrival of the second data may occur before or during the transmission of a PPDU 1308 to STA 1304. In an implementation, PPDU 1308 may be one of multiple PPDUs being transmitted to STA 1304 to transmit first data to STA 1304. In an example, the first data may be non-low latency data.

In an example, to transmit the second data, STA 1302 may transmit a PPDU 1310 comprising the second data a SIFS after an end of PPDU 1308. As PPDU 1310 is transmitted a SIFS, instead of an xIFS, after PPDU 1308, PPDU 1310 preempts a PPDU 1312 that would have been transmitted to STA 1304 and that would have contained the first data. In an implementation, STA 1302 may be configured to transmit PPDU 1310 in this manner based on receiving a frame (e.g., from an AP) indicating that preemption is allowed for the following TXOP. The AP or STA 1302 may be the holder of the TXOP. In an embodiment, STA 1302 may indicate in PPDU 1308 that pre-emption is disabled for PPDU 1308. In example 1300, such an indication may include setting a Pre-emption Indication field to 0. The Pre-emption Indication field being set to 0 prevents another STA (e.g., STA 1304 or STA 1306) from pre-empting the transmission of PPDU 1312, which could have cause a collision with the pre-empting PPDU 1310. In an embodiment, STA 1302 may be configured to set a Pre-emption Indication field to 0 upon reception of a low latency data frame that is scheduled to be transmitted after PPDU 1308.

In an implementation, STA 1306 may acknowledge PPDU 1310 by transmitting a BA frame 1314 to STA 1302. BA frame 1314 may be transmitted a SIFS after an end of PPDU 1310. STA 1302 may then resume transmission of the multiple PPDUs to STA 1204. For example, STA 1202 may transmit a PPDU 1214 comprising a second portion of the first data to STA 1204. In an implementation, STA 1202 may transmit PPDU 1214 an xIFS or a SIFS after transmitting BA frame 1212 to STA 1006. In an example, when PPDU 1214 is the final PPDU of the multiple PPDUs transmitted to STA 1204, STA 1204 may send a BA frame (not shown in FIG. 12) to STA 1202 on receiving PPDU 1214, marking the end of the TXOP.

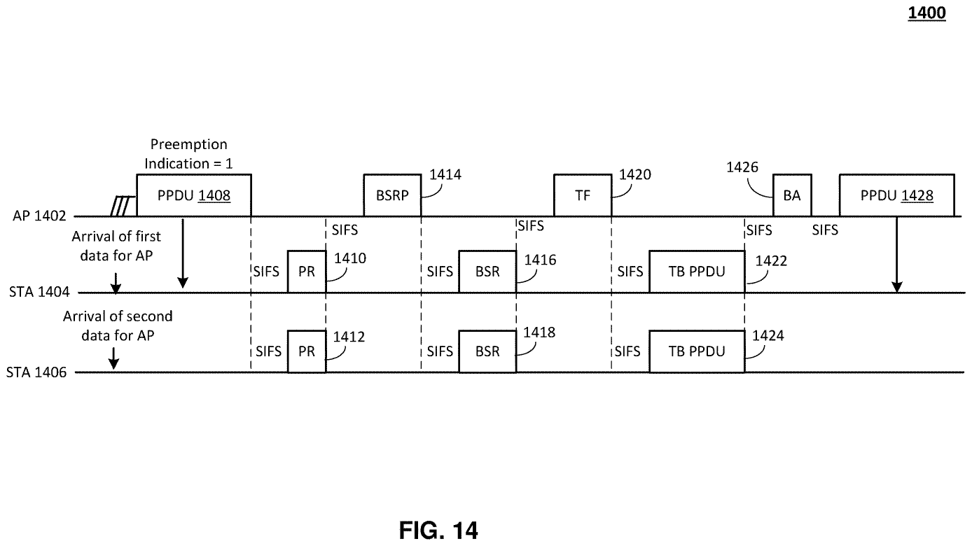

FIG. 14 is an example 1400 that illustrates an uplink preemption procedure using a preemption request. As shown in FIG. 14, example 1400 includes AP 1402, STA 1404, and STA 1406. STAs 1404 and 1406 may be associated with AP 1402.

As shown in FIG. 14, example 1400 may begin with the arrival at STA 1404 of first data for AP 1402 and at STA 1406 of second data for AP 1402. In an example, both the first data and the second data may be low latency data that requires urgent transmission to AP 1402. In an example, the arrival of the first data and the second data may occur before or during the transmission by AP 1402 of a PPDU 1408 to STA 1404. In an implementation, PPDU 1408 may be one of multiple PPDUs being transmitted to STA 1404 to transmit third data to STA 1404. In an example, the third data may be non-low latency data. PPDU 1408 may include a preemption indication that indicates whether preemption of a next PPDU following PPDU 1408 is allowed.

In example 1400, the preemption indication of PPDU 1408 may be set to 1 indicating that preemption of the next PPDU is allowed. As such, based on the arrival of the first data and the second data respectively, STAs 1404 and 1406 may preempt a next PPDU (not shown in FIG. 14) from AP 1402 to STA 1404 to transmit respective preemption request (PR) frames 1410 and 1412 to AP 1402. In an implementation, PR frames 1410 and 1412 are transmitted a SIFS after an end of PPDU 1408 to preempt the next PPDU from AP 1402 to STA 1404.

In an implementation, PR frames 1410 and 1412 are transmitted concurrently and over the same channel. As such, the respective PPDUs carrying PR frames 1410 and 1412 must be identical to avoid interfering at AP 1402. In an implementation, PR frames 1410 and 1412 may have a similar format as the CTS frame format illustrated in FIG. 4. In an implementation, to ensure that the respective PPDUs carrying PR frames 1410 and 1412 are identical, STAs 1404 and 1406 may be configured to set/generate the SIV part of the SERVICE field of the respective PPDUs (bits 0-6 of the SERVICE field after scrambling the DATA field of the PPDUs) carrying PR frames 1410 and 1412 to be equal to the SIV part of the SERVICE field of PPDU 1408 (bits 0-6 of the SERVICE field of PPDU 1408 before descrambling the DATA field of PPDU 1408). Additionally, STAs 1404 and 1406 may be configured to set the RA field of PR frames 1410 and 1412 based on a transmitter address (TA) comprised in PPDU 1408.

As PR frames 1410 and 1412 may be overlapping and identical, AP 1402 may not know which STAs transmitted a PR frame. In an implementation, AP 1402 may respond to PR frames 1410 and 1412 by transmitting a buffer status report poll (BSRP) frame 1414. BSRP frame 1414 may be transmitted a SIFS after an end of PR frames 1410 and 1412. BSRP frame 1414 solicits buffer status report (BSR) frames from all STAs to allow AP 1402 to determine the STAs that have low latency traffic to transmit to AP 1402. In example 1400, as both STAs 1404 and 1406 have low latency traffic to transmit to AP 1402, STAs 1404 and 1406 may respond to BSRP frame 1414 with BSR frames 1416 and 1418 respectively. BSR frames 1416 and 1418 indicate to AP 1402 that STAs 1404 and 1406 have low latency traffic for AP 1402. BSR frames 1416 and 1418 may be transmitted a SIFS after an end of BSRP frame 1414.

Subsequently, based on receiving BSR frames 1416 and 1418, AP 1402 may transmit a trigger frame 1420 to STAs 1404 and 1406. Trigger frame 1420 solicits trigger-based (TB) uplink transmissions from STAs 1404 and 1406. Trigger frame 1420 may be transmitted a SIFS after an end of BSR frames 1416 and 1418. STAs 1404 and 1406 may respond to trigger frame 1420 by transmitting TB PPDUs 1422 and 1424 respectively. TB PPDUs 1422 and 1424 may be transmitted a SIFS after an end of trigger frame 1420. In an example, TB PPDUs 1422 and 1424 may be transmitted over orthogonal frequency resources.

In an example, AP 1402 may acknowledge TB PPDUs 1422 and 1424 by transmitting a BA frame 1426. BA frame 1426 may be transmitted a SIFS after an end of TB PPDUs 1422 and 1424. In an example, AP 1402 may resume transmission of the third data to STA 1404 by transmitting a PPDU 1428 a SIFS after an end of BA frame 1426.

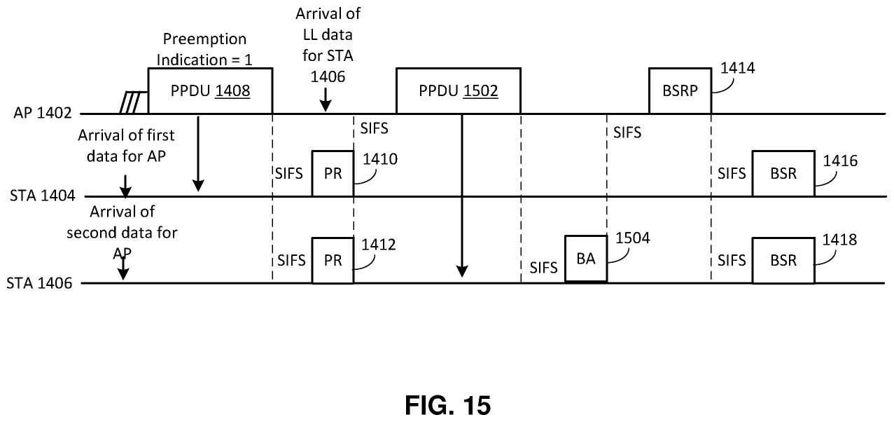

In an example, illustrated in FIG. 15, AP 1402 may have low latency data for STA 1406 arrive before or during the reception of PR frames 1410 and 1412 from STAs 1404 and 1412. In an implementation, AP 1402 may be configured to transmit the low latency data before responding to PR frames 1410 and 1412. As such, as shown in FIG. 15, AP 1402 may transmit a PPDU 1502 comprising the low latency data to STA 1406 a SIFS after receiving PR frames 1410 and 1412. PPDU 1502 may thus preempt a next PPDU (not shown in FIG. 15) from AP 1402 to STA 1404 that would have comprised the third data, for example.

In an implementation, STA 1406 may acknowledge PPDU 1502 by transmitting a BA frame 1504 to AP 1402. After receiving BA frame 1504 (e.g., a SIFS after receiving BA frame 1504), AP 1402 may respond to PR frames 1410 and 1412 by transmitting BSRP frame 1414 as described above with reference to FIG. 14. The procedure may then continue as described above in FIG. 14.

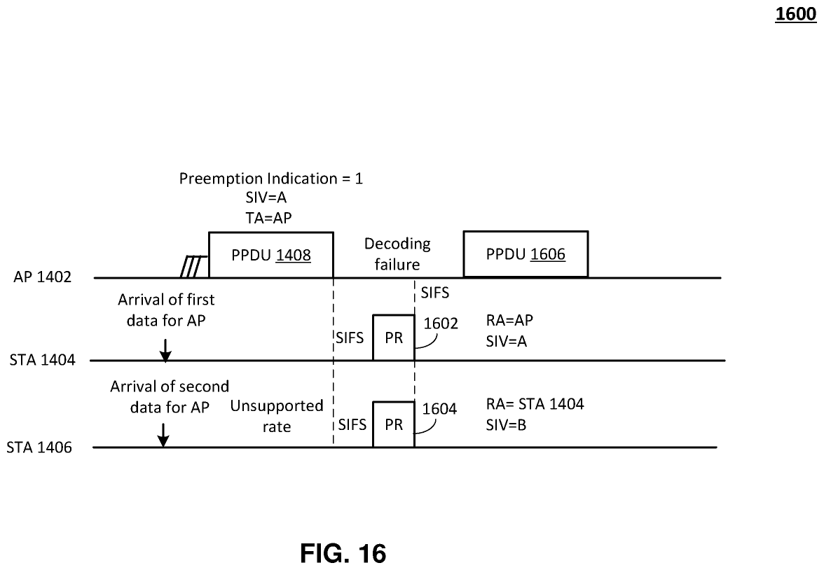

FIG. 16 is an example 1600 that illustrates a problem that may arise in the uplink preemption procedure of FIG. 14. As shown in FIG. 16, example 1600 also includes AP 1402, STA 1404, and STA 1406 described in FIG. 14.

Like example 1400 of FIG. 14, example 1600 may begin with the arrival at STA 1404 of first data for AP 1402 and at STA 1406 of second data for AP 1402. In an example, both the first data and the second data may be low latency data that requires urgent transmission to AP 1402. In an example, the arrival of the first data and the second data may occur before or during the transmission by AP 1402 of a PPDU 1408 to STA 1404. In an implementation, PPDU 1408 may be one of multiple PPDUs being transmitted to STA 1404 to transmit third data to STA 1404. In an example, the third data may be non-low latency data. PPDU 1408 may include a preemption indication that indicates whether preemption of a next PPDU following PPDU 1408 is allowed.

In example 1600, the preemption indication of PPDU 1408 may be set to 1 indicating that preemption of the next PPDU is allowed. As such, based on the arrival of the first data and the second data respectively, STAs 1404 and 1406 may preempt a next PPDU (not shown in FIG. 16) from AP 1402 to STA 1404 to transmit respective PR frames 1602 and 1604 to AP 1402. In an implementation, PR frames 1602 and 1604 are transmitted a SIFS after an end of PPDU 1408 to preempt the next PPDU from AP 1402 to STA 1404.

In example 1600, STA 1404 may be able to decode the PHY header, the SERVICE field, and/or at least one MPDU of the PSDU of PPDU 1408. In an implementation, STA 1404 may obtain, from the PHY header, the preemption indication of PPDU 1408 and may determine that preemption of the next PPDU is allowed. In an implementation, STA 1404 may obtain, from the SERVICE field (before descrambling), the SIV part (bits 0-6) of the SERVICE field. In an implementation, STA 1404 may obtain, from the at least one MPDU of the PSDU, the TA of PPDU 1408 (e.g., the TA of PPDU 1408 may be set to an identifier of AP 1402). In an implementation, STA 1404 may use the obtained SIV part of the SERVICE field of PPDU 1408 to set/generate the SIV part of the SERVICE field of the PPDU (bits 0-6 of the SERVICE field after scrambling the DATA field of the PPDU) carrying PR frame 1602. In an implementation, STA 1404 may use the obtained TA of PPDU 1408 to set the RA of PR frame 1602.

In contrast, in example 1600, despite being able to decode the PHY header of PPDU 1408, STA 1406 may not be able to decode the SERVICE field and/or at least one MPDU of the PSDU of PPDU 1408. This may be due to STA 1406 not supporting the MCS used for the SERVICE field and the PSDU of PPDU 1408 (e.g., a higher MCS may be used for the SERVICE field and the PSDU of PPDU 1408 than for the PHY header of PPDU 1408). As such, STA 1406 may determine that preemption of a next PPDU is allowed. However, STA 1406 may not set/generate the SIV part of the SERVICE field of the PPDU (bits 0-6 of the SERVICE field of the PPDU after scrambling the DATA field of the PPDU) carrying PR frame 1604 in the same manner as STA 1404. In an implementation, STA 1406 may set the SIV part of the SERVICE field of the PPDU carrying PR frame 1604 based on the assumption that the “SCRAMBLER_INITIAL_VALUE is present” condition is false. As such, as shown in FIG. 16, the SIV part of the SERVICE field of the PPDU carrying PR frame 1604 may be different from the SIV part of the SERVICE field of the PPDU carrying PR frame 1602. Additionally, or alternatively, STA 1406 may not set the RA of PR frame 1604 in the same manner as STA 1404. As such, as shown in FIG. 16, the RA of PR frame 1604 may be different from the RA of PR frame 1602. This results in the PPDUs carrying PR frames 1602 and 1604 being different from each other and may lead to AP 1402 failing to decode PR frames 1602 and 1604. The uplink preemption procedure of FIG. 4 may thus fail with AP 1402 not transmitting BSRP frame 1414 and instead continuing with the transmission of a PPDU 1606 comprising the third data (e.g., non-low latency data) to STA 1404.

Embodiments of the present disclosure, as further described below, address the above-described problem. In one aspect, a first STA may transmit a first PPDU comprising a field used to determine whether preemption of a second PPDU following the first PPDU is allowed and a first scrambler initial value for descrambling a data field of the first PPDU. Based on the field indicating allowance of preemption of the second PPDU, a second STA may transmit a third PPDU comprising a second scrambler initial value. The second scrambler initial value may be different from the first scrambler initial value. The second scrambler initial value may be provided in a PHY header of the first PPDU, may be based on one or more fields of the PHY header of the first PPDU, or may be based on a BSS color or a BSSID of an AP with which the second STA is associated. In another aspect, the second STA may transmit the second PPDU on condition of decoding at least one MPDU of the first PPDU. The second scrambler initial value may be based on the first scrambler initial value. In a further aspect, the second STA may receive a fourth PPDU comprising the second scrambler initial value. The fourth PPDU may be transmitted by an AP.

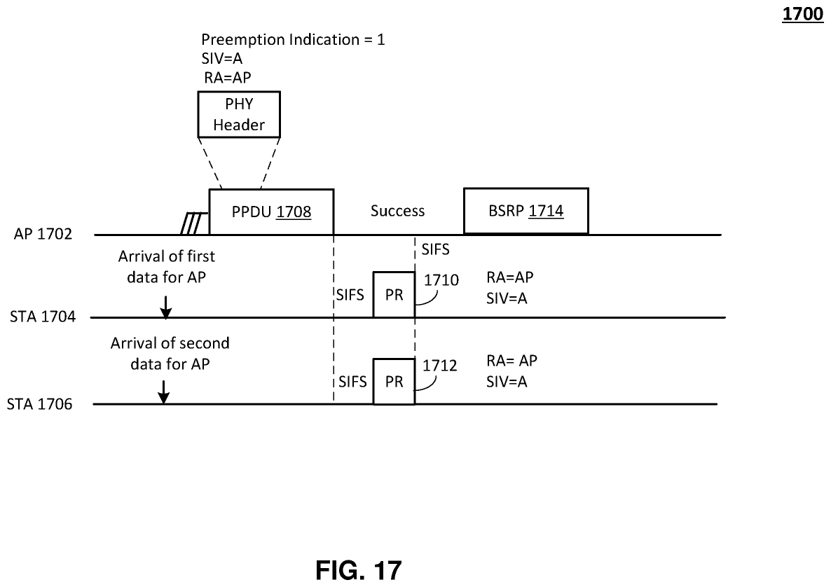

FIG. 17 is an example 1700 that illustrates an uplink preemption procedure according to an embodiment. As shown in FIG. 17, example 1700 includes an AP 1702, a STA 1704, and a STA 1706. STAs 1704 and 1706 may be associated with AP 1702.

As shown in FIG. 17, example 1700 may begin with the arrival at STA 1704 of first data for AP 1702 and at STA 1706 of second data for AP 1702. In an example, both the first data and the second data may be low latency data that requires urgent transmission to AP 1702. In an example, the arrival of the first data and the second data may occur before or during the transmission by AP 1702 of a PPDU 1708 to STA 1704. In an implementation, PPDU 1708 may be one of multiple PPDUs being transmitted to STA 1704 to transmit third data to STA 1704. In an example, the third data may be non-low latency data. PPDU 1708 may include a preemption indication that indicates whether preemption of a next PPDU following PPDU 1708 is allowed.

In example 1700, the preemption indication of PPDU 1708 may be set to 1 indicating that preemption of the next PPDU is allowed. In an embodiment, the preemption indication may be provided in a PHY header (e.g., U-SIG or NG-SIG) of PPDU 1708, which improves the chance that both STAs 1704 and 1706 obtain the preemption indication. As such, based on the arrival of the first data and the second data respectively, STAs 1704 and 1706 may preempt a next PPDU (not shown in FIG. 17) from AP 1702 to STA 1704 to transmit respective PR frames 1710 and 1712 to AP 1702. In an implementation, PR frames 1710 and 1712 are transmitted a SIFS after an end of PPDU 1708 to preempt the next PPDU from AP 1702 to STA 1704.

In an implementation, PR frames 1710 and 1712 are transmitted concurrently and over the same channel. In an embodiment, PPDU 1708 may be configured to comprise a scrambler initial value. In an embodiment, STAs 1704 and 1706 may be configured to use the scrambler initial value provided in PPDU 1708 to set/generate the SIV part of the SERVICE field of the respective PPDUs (bits 0-6 of the SERVICE field after scrambling the DATA field of the PPDUs) carrying PR frames 1710 and 1712. It is noted that the SIV part of the SERVICE field of the respective PPDUs carrying PR frames 1710 and 1712 may be used by a receiver of the respective PPDUs as a scrambler initial value for descrambling the DATA fields of the PPDUs. It is noted that the scrambler initial value provided in the PHY header of PPDU 1708 may be in addition to another scrambler initial value found in the SIV part of the SERVICE field of PPDU 1708 (and which may be used to descramble the DATA field of PPDU 1708). In another embodiment, PPDU 1708 may, alternatively or additionally, comprise a receiver address (RA) for PR frames 1710 and 1712. The RA may be equal to the TA of PPDU 1708. It is noted that the RA provided in the PHY header of PPDU 1708 may be in addition to another RA found in the MAC header of PPDU 1708 (and which indicates the receiver STA of the MPDU carried by the PPDU). In an embodiment, STAs 1704 and 1706 may be configured to use the RA provided in PPDU 1708 to set the RA of respectively PR frames 1710 and 1712. As shown in example 1700, both the RA and SIV are provided in the PHY header of PPDU 1708. In another embodiment, the RA and/or SIV may be provided in a new signal field located within the DATA field (e.g., middle or end) of PPDU 1708.

As the scrambler initial value and the RA of PR frames 1710 and 1712 are provided in the PHY header or new signal field of PPDU 1708, the probability of STAs 1704 and 1706 obtaining the scrambling initial value and the RA of PR frames 1710 and 1712 may be increased. In an embodiment, the scrambler initial value and/or the RA of PR frames 1710 and 1712 may be provided in the SIGNAL field of PPDU 1708. As mentioned above, the SIGNAL field is transmitted using the most robust combination of BPSK modulation and a coding rate of R=½. In an embodiment, the scrambler initial value and/or the RA of PR frames 1710 and 1712 may be provided in a U-SIG or a NG-SIG (e.g., UHR-SIG) of PPDU 1708. In an embodiment, STAs 1704 and 1706 may be configured to transmit PR frames 1710 and 1712 without decoding the SERVICE field and/or the PSDU of PPDU 1708.

As shown in FIG. 17, with STAs 1704 and 1706 operating as described above, the respective PPDUs carrying PR frames 1710 and 1712 are guaranteed to be identical and may thus be received successfully by AP 1702. AP 1702 may thus respond to PR frames 1710 and 1712 by transmitting a BSRP frame 1714. BSRP frame 1714 may be transmitted a SIFS after an end of PR frames 1710 and 1712. BSRP frame 1714 solicits BSR frames from all STAs to allow AP 1702 to determine the STAs that have low latency traffic to transmit to AP 1702.

In example 1700, as both STAs 1704 and 1706 have low latency traffic to transmit to AP 1702, STAs 1704 and 1706 may respond to BSRP frame 1714 with respective BSR frames (not shown in FIG. 17). The respective BSR frames indicate to AP 1702 that STAs 1704 and 1706 have low latency traffic for AP 1702. The respective BSR frames may be transmitted a SIFS after an end of BSRP frame 1414. Subsequently, based on receiving the respective BSR frames, AP 1402 may transmit a trigger frame (not shown in FIG. 17) to STAs 1704 and 1706. The trigger frame solicits TB uplink transmissions from STAs 1704 and 1706. The trigger frame may be transmitted a SIFS after an end of the BSR frames. STAs 1704 and 1706 may respond to the trigger frame by transmitting respective TB PPDUs (not shown in FIG. 17) to AP 1702. The respective PPDUs may comprise the first data from STA 1704 and the second data from STA 1706 respectively. The respective TB PPDUs may be transmitted a SIFS after an end of the trigger frame. In an example, the respective TB PPDUs may be transmitted over orthogonal frequency resources.

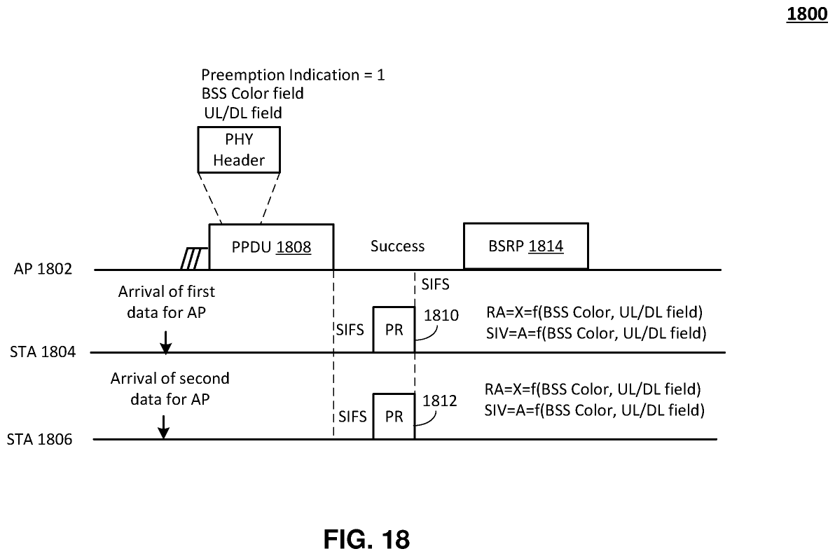

FIG. 18 is an example 1800 that illustrates another uplink preemption procedure according to an embodiment. As shown in FIG. 18, example 1800 includes an AP 1802, a STA 1804, and a STA 1806. STAs 1804 and 1806 may be associated with AP 1802.

As shown in FIG. 18, example 1800 may begin with the arrival at STA 1804 of first data for AP 1802 and at STA 1806 of second data for AP 1802. In an example, both the first data and the second data may be low latency data that requires urgent transmission to AP 1802. In an example, the arrival of the first data and the second data may occur before or during the transmission by AP 1802 of a PPDU 1808 to STA 1804. In an implementation, PPDU 1808 may be one of multiple PPDUs being transmitted to STA 1804 to transmit third data to STA 1804. In an example, the third data may be non-low latency data. PPDU 1808 may include a preemption indication that indicates whether preemption of a next PPDU following PPDU 1808 is allowed.

In example 1800, the preemption indication of PPDU 1808 may be set to 1 indicating that preemption of the next PPDU is allowed. In an embodiment, the preemption indication may be provided in a PHY header (e.g., U-SIG or NG-SIG) of PPDU 1808, which improves the chance that both STAs 1804 and 1806 obtain the preemption indication. As such, based on the arrival of the first data and the second data respectively, STAs 1804 and 1806 may preempt a next PPDU (not shown in FIG. 18) from AP 1802 to STA 1804 to transmit respective PR frames 1810 and 1812 to AP 1802. In an implementation, PR frames 1810 and 1812 are transmitted a SIFS after an end of PPDU 1808 to preempt the next PPDU from AP 1802 to STA 1804.

In an implementation, PR frames 1810 and 1812 are transmitted concurrently and over the same channel. In an embodiment, the PHY header of PPDU 1808 comprises a plurality of fields. For example, as shown in FIG. 5, a U-SIG (or an NG-SIG) of PPDU 1808 may comprise a PHY Version Identifier field, a BSS Color field, a bandwidth (BW) field, an UL/DL field, or a TXOP field. In an embodiment, STAs 1804 and 1806 may be configured to determine a scrambler initial value as a function of one or more of the plurality of fields. In an embodiment, STAs 1804 and 1806 may be configured to use the determined scrambler initial value to set/generate the SIV part of the SERVICE field of the respective PPDUs (bits 0-6 of the SERVICE field after scrambling the DATA field of the PPDUs) carrying PR frames 1810 and 1812. The SIV part of the SERVICE field of the respective PPDUs carrying PR frames 1710 and 1712 may be used by a receiver of the respective PPDUs as a scrambler initial value for descrambling the DATA fields of the PPDUs. It is noted that the determined scrambler initial value may be different than a scrambler initial value found in the SIV part of the SERVICE field of PPDU 1808 (and which may be used to descramble the DATA field of PPDU 1808). In another embodiment, STAs 1804 and 1806 may be configured, alternatively or additionally, to determine a receiver address (RA) as a function of one or more of the plurality of fields of the PHY header of PPDU 1808. In an embodiment, STAs 1804 and 1806 may be configured to use the determined RA to set the RA of respectively PR frames 1810 and 1812.

As the scrambler initial value and the RA of PR frames 1810 and 1812 are determined based on one or more fields of the PHY header of PPDU 1808, the probability of STAs 1804 and 1806 determining the scrambler initial value and the RA of PR frames 1810 and 1812 may be increased. In an embodiment, STAs 1804 and 1806 may be configured to transmit PR frames 1810 and 1812 without decoding the SERVICE field and/or the PSDU of PPDU 1808.

As shown in FIG. 18, with STAs 1804 and 1806 operating as described above, the respective PPDUs carrying PR frames 1810 and 1812 are guaranteed to be identical and may thus be received successfully by AP 1802. AP 1802 may thus respond to PR frames 1810 and 1812 by transmitting a BSRP frame 1814. BSRP frame 1814 may be transmitted a SIFS after an end of PR frames 1810 and 1812. BSRP frame 1814 solicits BSR frames from all STAs to allow AP 1802 to determine the STAs that have low latency traffic to transmit to AP 1802.

In example 1800, as both STAs 1804 and 1806 have low latency traffic to transmit to AP 1802, STAs 1804 and 1806 may respond to BSRP frame 1814 with respective BSR frames (not shown in FIG. 18). The respective BSR frames indicate to AP 1802 that STAs 1804 and 1806 have low latency traffic for AP 1802. The respective BSR frames may be transmitted a SIFS after an end of BSRP frame 1414. Subsequently, based on receiving the respective BSR frames, AP 1402 may transmit a trigger frame (not shown in FIG. 18) to STAs 1804 and 1806. The trigger frame solicits TB uplink transmissions from STAs 1804 and 1806. The trigger frame may be transmitted a SIFS after an end of the BSR frames. STAs 1804 and 1806 may respond to the trigger frame by transmitting respective TB PPDUs (not shown in FIG. 18) to AP 1802. The respective PPDUs may comprise the first data from STA 1804 and the second data from STA 1806 respectively. The respective TB PPDUs may be transmitted a SIFS after an end of the trigger frame. In an example, the respective TB PPDUs may be transmitted over orthogonal frequency resources.

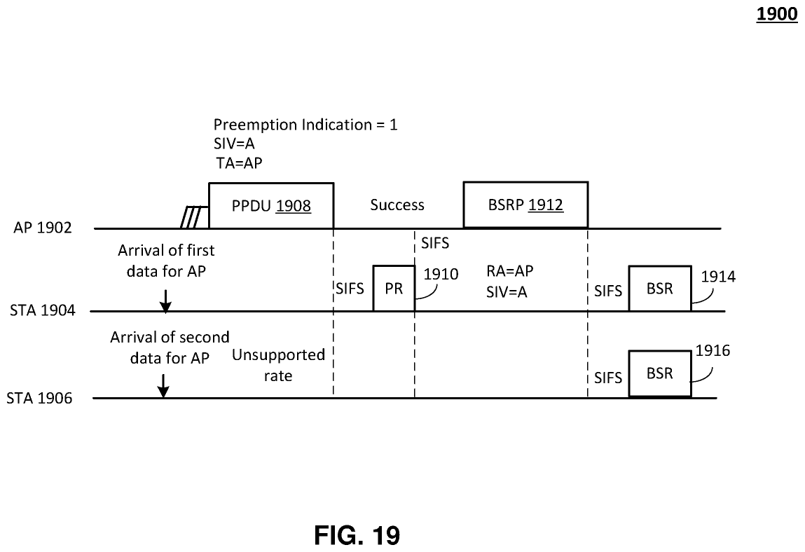

FIG. 19 is an example that illustrates another uplink preemption procedure according to an embodiment. As shown in FIG. 19, example 1900 includes an AP 1902, a STA 1904, and a STA 1906. STAs 1904 and 1906 may be associated with AP 1902.

As shown in FIG. 19, example 1900 may begin with the arrival at STA 1904 of first data for AP 1902 and at STA 1906 of second data for AP 1902. In an example, both the first data and the second data may be low latency data that requires urgent transmission to AP 1902. In an example, the arrival of the first data and the second data may occur before or during the transmission by AP 1902 of a PPDU 1908 to STA 1904. In an implementation, PPDU 1908 may be one of multiple PPDUs being transmitted to STA 1904 to transmit third data to STA 1904. In an example, the third data may be non-low latency data. PPDU 1908 may include a preemption indication that indicates whether preemption of a next PPDU following PPDU 1908 is allowed.

In example 1900, the preemption indication of PPDU 1908 may be set to 1 indicating that preemption of the next PPDU is allowed. In an embodiment, the preemption indication may be provided in a PHY header (e.g., U-SIG or NG-SIG) of PPDU 1908, which improves the chance that both STAs 1904 and 1906 obtain the preemption indication. As such, based on the arrival of the first data and the second data respectively, STAs 1904 and 1906 may be configured to preempt a next PPDU (not shown in FIG. 19) from AP 1902 to STA 1904.

In an embodiment, STAs 1904 and 1906 may each be configured to transmit a respective PR frame to preempt the next PPDU on condition of decoding at least one MPDU of PPDU 1908. In an embodiment, this allows STA 1904 or 1906 to obtain a TA of PPDU 1908. In an embodiment, STA 1904 or 190 may be configured to set the RA of the respective PR frame based on the TA of PPDU 1908. In another embodiment, STAs 1904 and 1906 may each be configured to transmit a respective PR frame to preempt the next PPDU, alternatively or additionally, on condition of decoding the SERVICE field of PPDU 1908. In an embodiment, this allows STA 1904 or 1906 to obtain a SIV part of the SERVICE field of PPDU 1908 ((bits 0-6 of the SERVICE field of PPDU 1908 before descrambling the DATA field of the PPDU 1908)). In an embodiment, STA 1904 or 1906 may be configured to set/generate a SIV part of a SERVICE field of the PPDU (bits 0-6 of the SERVICE field after scrambling the DATA field of the PPDU) carrying the respective PR frame based on the obtained SIV part of the SERVICE field of PPDU 1908. It is noted that the SIV part of the SERVICE field of the PPDU carrying the respective PR frame may be used by a receiver of the PPDU as a scrambler initial value for descrambling the DATA field of the PPDU. In another embodiment, decoding at least one MPDU of PPDU 1908 may imply or necessitate decoding the SERVICE field of PPDU 1908. As such, STAs 1904 and 1906 may each be configured to transmit a respective PR frame to preempt the next PPDU on the sole condition of decoding at least one MPDU of PPDU 1908.

In example 1900, only STA 1904 may be able to decode at least one MPDU of PPDU 1908. As such, only STA 1904 may transmit a PR frame 1910 to AP 1902. PR frame 1910 may be transmitted a SIFS after an end of PPDU 1908. As only STAs able to decode at least one MPDU of PPDU 1908 (and thus obtain the TA of PPDU 1908 and the SIV part of the SERVICE field of PPDU 1908) are allowed to transmit a PR frame, when multiple PR frames are transmitted the transmitted PR frames are guaranteed to be identical and may thus be received successfully by AP 1902. In example 1900, AP 1902 may respond to PR frame 1910 by transmitting a BSRP frame 1912. BSRP frame 1912 may be transmitted a SIFS after an end of PR frame 1910. BSRP frame 1912 solicits BSR frames from all STAs to allow AP 1902 to determine the STAs that have low latency traffic to transmit to AP 1902.

In example 1900, as both STAs 1904 and 1906 have low latency traffic to transmit to AP 1902, STAs 1904 and 1906 may respond to BSRP frame 1912 with respective BSR frames 1914 and 1916. BSR frames 1914 and 1916 indicate to AP 1902 that STAs 1904 and 1906 have low latency traffic for AP 1902. BSR frames 1914 and 1916 may be transmitted a SIFS after an end of BSRP frame 1912. Subsequently, based on receiving BSR frames 1914 and 1916, AP 1902 may transmit a trigger frame (not shown in FIG. 19) to STAs 1904 and 1906. The trigger frame solicits TB uplink transmissions from STAs 1904 and 1906. The trigger frame may be transmitted a SIFS after an end of BSR frames 1914 and 1916. STAs 1904 and 1906 may respond to the trigger frame by transmitting respective TB PPDUs (not shown in FIG. 19) to AP 1902. The respective PPDUs may comprise the first data from STA 1904 and the second data from STA 1906 respectively. The respective TB PPDUs may be transmitted a SIFS after an end of the trigger frame. In an example, the respective TB PPDUs may be transmitted over orthogonal frequency resources.

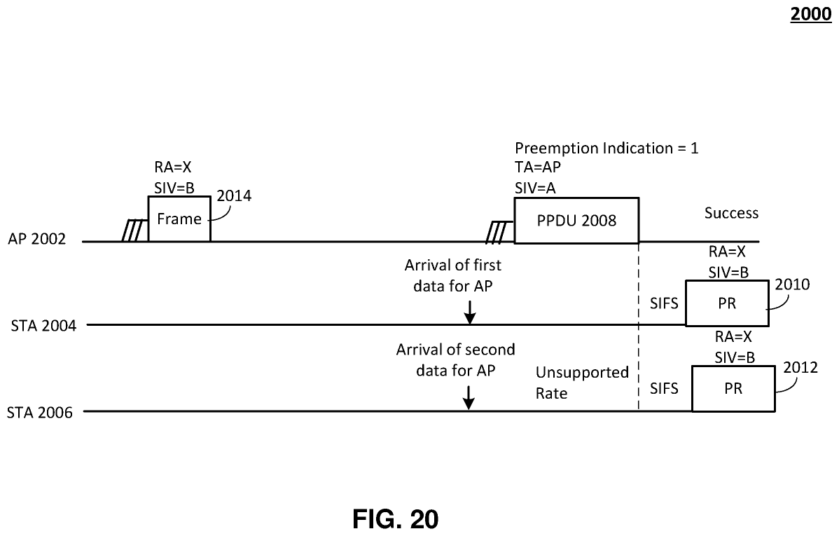

FIG. 20 is an example 2000 that illustrates another uplink preemption procedure according to an embodiment. As shown in FIG. 20, example 2000 includes an AP 2002, a STA 2004, and a STA 2006. STAs 2004 and 2006 may be associated with AP 2002.

As shown in FIG. 20, example 2000 may begin with AP 2002 transmitting a frame 2014. Frame 2014 may be a control frame or a management frame. For example, frame 2014 may be a beacon frame, a probe response frame, or an association response frame. In an embodiment, AP 2002 may transmit frame 2014 periodically. In an embodiment, frame 2014 may comprise or indicate a receiver address (RA) and/or a scrambler initial value.

Subsequently, first data for AP 2002 may arrive at STA 2004 and second data for AP 2002 may arrive at STA 2006. In an example, both the first data and the second data may be low latency data that requires urgent transmission to AP 2002. In an example, the arrival of the first data and the second data may occur before or during the transmission by AP 2002 of a PPDU 2008 to STA 2004. In an implementation, PPDU 2008 may be one of multiple PPDUs being transmitted to STA 2004 to transmit third data to STA 2004. In an example, the third data may be non-low latency data. PPDU 2008 may include a preemption indication that indicates whether preemption of a next PPDU following PPDU 2008 is allowed.

In example 2000, the preemption indication of PPDU 2008 may be set to 1 indicating that preemption of the next PPDU is allowed. In an embodiment, the preemption indication may be provided in a PHY header (e.g., U-SIG or NG-SIG) of PPDU 2008, which improves the chance that both STAs 2004 and 2006 obtain the preemption indication. As such, based on the arrival of the first data and the second data respectively, STAs 2004 and 2006 may be configured to preempt a next PPDU (not shown in FIG. 20) from AP 2002 to STA 2004 to transmit respective PR frames 2010 and 2012 to AP 2002. In an implementation, PR frames 2010 and 2012 are transmitted a SIFS after an end of PPDU 2008 to preempt the next PPDU from AP 2002 to STA 2004.

In an implementation, PR frames 2010 and 2012 are transmitted concurrently and over the same channel. In an embodiment, STAs 2004 and 2006 may be configured to use the scrambler initial value provided in frame 2014 to set/generate the SIV part of the SERVICE field of the respective PPDUs (bits 0-6 of the SERVICE field after scrambling the DATA field of the PPDUs) carrying PR frames 2010 and 2012. It is noted that the SIV part of the SERVICE field of the respective PPDUs carrying PR frames 2010 and 2012 may be used by a receiver of the respective PPDUs as a scrambler initial value for descrambling the DATA fields of the PPDUs. In an embodiment, PPDU 2008 may be configured to comprise a scrambler initial value. In an embodiment, STAs 2004 and 2006 may be configured to use the scrambler initial value in PPDU 2008 to descramble the DATA field of PPDU 2008. In another embodiment, STAs 2004 and 2006 may be configured, alternatively or additionally, to use the RA provided in frame 2014 to set the RA of respectively PR frames 2010 and 2012. As such, STAs 2004 and 2006 may not use a receiver address (e.g., corresponding to the TA of PPDU 2008) that may be provided in PPDU 2008.

As the scrambler initial value and the RA of PR frames 2010 and 2012 are provided in frame 2014, the probability of STAs 2004 and 2006 obtaining the scrambling initial value and the RA of PR frames 2010 and 2012 may be increased. This may be due to frame 2014 being transmitted periodically and/or using a robust MCS.

As shown in FIG. 20, with STAs 2004 and 2006 operating as described above, the respective PPDUs carrying PR frames 2010 and 2012 are guaranteed to be identical and may thus be received successfully by AP 2002. AP 2002 may thus respond to PR frames 2010 and 2012 by transmitting a BSRP frame (not shown in FIG. 20). The BSRP frame may be transmitted a SIFS after an end of PR frames 2010 and 2012. The BSRP frame solicits BSR frames from all STAs to allow AP 2002 to determine the STAs that have low latency traffic to transmit to AP 2002. In example 2000, as both STAs 2004 and 2006 have low latency traffic to transmit to AP 2002, STAs 2004 and 2006 may respond to the BSRP frame with respective BSR frames (not shown in FIG. 20). The respective BSR frames indicate to AP 2002 that STAs 2004 and 2006 have low latency traffic for AP 2002. The respective BSR frames may be transmitted a SIFS after an end of the BSRP frame. Subsequently, based on receiving the respective BSR frames, AP 2002 may transmit a trigger frame (not shown in FIG. 20) to STAs 2004 and 2006. The trigger frame solicits TB uplink transmissions from STAs 2004 and 2006. The trigger frame may be transmitted a SIFS after an end of the respective BSR frames. STAs 2004 and 2006 may respond to the trigger frame by transmitting respective TB PPDUs (not shown in FIG. 20) to AP 2002. The respective PPDUs may comprise the first data from STA 2004 and the second data from STA 2006 respectively. The respective TB PPDUs may be transmitted a SIFS after an end of the trigger frame. In an example, the respective TB PPDUs may be transmitted over orthogonal frequency resources.

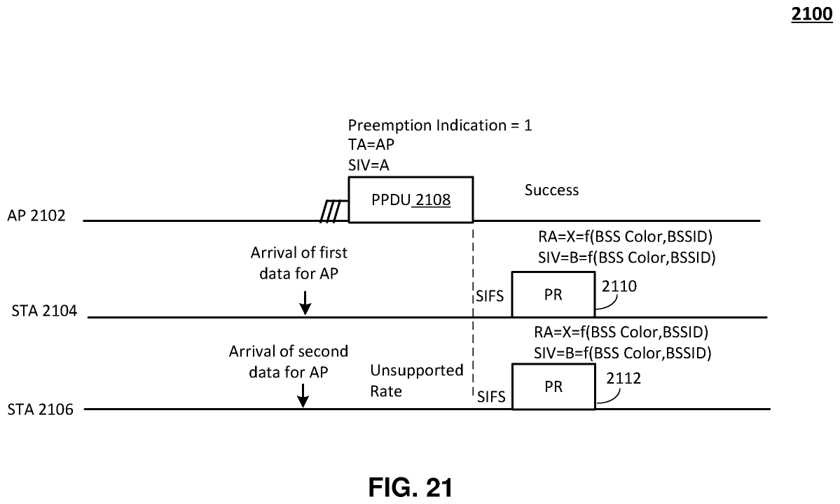

FIG. 21 is an example 2100 that illustrates an uplink preemption procedure according to an embodiment. As shown in FIG. 2, example 2100 includes an AP 2102, a STA 2104, and a STA 2106. STAs 2104 and 2106 may be associated with AP 2102.

As shown in FIG. 21, example 2100 may begin with the arrival at STA 2104 of first data for AP 2102 and at STA 2106 of second data for AP 2102. In an example, both the first data and the second data may be low latency data that requires urgent transmission to AP 2102. In an example, the arrival of the first data and the second data may occur before or during the transmission by AP 2102 of a PPDU 2108 to STA 2104. In an implementation, PPDU 2108 may be one of multiple PPDUs being transmitted to STA 2104 to transmit third data to STA 2104. In an example, the third data may be non-low latency data. PPDU 2108 may include a preemption indication that indicates whether preemption of a next PPDU following PPDU 2108 is allowed.

In example 2100, the preemption indication of PPDU 2108 may be set to 1 indicating that preemption of the next PPDU is allowed. In an embodiment, the preemption indication may be provided in a PHY header (e.g., U-SIG or NG-SIG) of PPDU 2108, which improves the chance that both STAs 2104 and 2106 obtain the preemption indication. As such, based on the arrival of the first data and the second data respectively, STAs 2104 and 2106 may be configured to preempt a next PPDU (not shown in FIG. 21) from AP 2102 to STA 2104 to transmit respective PR frames 2110 and 2112 to AP 2102. In an implementation, PR frames 2110 and 2112 are transmitted a SIFS after an end of PPDU 2108 to preempt the next PPDU from AP 2102 to STA 2104.

In an implementation, PR frames 2110 and 2112 are transmitted concurrently and over the same channel. In an embodiment, STAs 2104 and 2106 may be configured to determine a scrambler initial value as a function of one or more attributes of a BSS to which STAs 2104 and 2106 belong. For example, the scrambler initial value may be determined as a function of one or more of a BSS color of the BSS or a BSSID of an AP with which STAs 2104 and 2106 are associated (e.g., AP 2102). In an embodiment, STAs 2104 and 2106 may be configured to use the determined scrambler initial value to set/generate the SIV part of the SERVICE field of the respective PPDUs (bits 0-6 of the SERVICE field after scrambling the DATA field of the PPDUs) carrying PR frames 2110 and 2112. The SIV part of the SERVICE field of the respective PPDUs carrying PR frames 2110 and 2112 may be used by a receiver of the respective PPDUs as a scrambler initial value for descrambling the DATA fields of the PPDUs. It is noted that the determined scrambler initial value may be different than a scrambler initial value found in the SIV part of the SERVICE field of PPDU 2108 (and which may be used to descramble the DATA field of PPDU 218). In another embodiment, STAs 2104 and 2106 may be configured, alternatively or additionally, to determine a receiver address (RA) as a function of one or more attributes of a BSS to which STAs 2104 and 2106 belong. For example, the RA may be determined as a function of one or more of a BSS color of the BSS or a BSSID of an AP with which STAs 2104 and 2106 are associated (e.g., AP 2102). In an embodiment, STAs 2104 and 2106 may be configured to use the determined RA to set the RA of respectively PR frames 2110 and 2112. In another embodiment (not shown in FIG. 21), STAs 2104 and 2106 may be configured to set the SIV part of the SERVICE field of the respective PPDUs (bits 0-6 of the SERVICE field after scrambling the DATA field of the PPDUs) carrying PR frames 2110 and 2112 and/or the RA of PR frames 2110 and 2112 to a pre-defined (e.g., constant) value.

As the scrambler initial value and the RA of PR frames 2110 and 2112 are determined based on one or more attributes of the BSS to which STAs 2104 and 2106 belong (or set according to pre-defined values), it can be guaranteed that the respective PPDUs carrying PR frames 2110 and 2112 use the same SIV part (bits 0-6) for the SERVICE field and that PR frames 2110 and 2112 use the same RA value. Indeed, as shown in FIG. 21, with STAs 2104 and 2106 operating as described above, the respective PPDUs carrying PR frames 2110 and 2112 are guaranteed to be identical and may thus be received successfully by AP 2102. AP 2102 may thus respond to PR frames 2110 and 2112 by transmitting a BSRP frame (not shown in FIG. 21). The BSRP frame may be transmitted a SIFS after an end of PR frames 2110 and 2112. The BSRP frame solicits BSR frames from all STAs to allow AP 2102 to determine the STAs that have low latency traffic to transmit to AP 2102. In example 2100, as both STAs 2104 and 2106 have low latency traffic to transmit to AP 2102, STAs 2104 and 2106 may respond to the BSRP frame with respective BSR frames (not shown in FIG. 21). The respective BSR frames indicate to AP 2102 that STAs 2104 and 2106 have low latency traffic for AP 2102. The respective BSR frames may be transmitted a SIFS after an end of the BSRP frame. Subsequently, based on receiving the respective BSR frames, AP 2102 may transmit a trigger frame (not shown in FIG. 21) to STAs 2104 and 2106. The trigger frame solicits TB uplink transmissions from STAs 2104 and 2106. The trigger frame may be transmitted a SIFS after an end of the respective BSR frames. STAs 2104 and 2106 may respond to the trigger frame by transmitting respective TB PPDUs (not shown in FIG. 21) to AP 2102. The respective PPDUs may comprise the first data from STA 2104 and the second data from STA 2106 respectively. The respective TB PPDUs may be transmitted a SIFS after an end of the trigger frame. In an example, the respective TB PPDUs may be transmitted over orthogonal frequency resources.

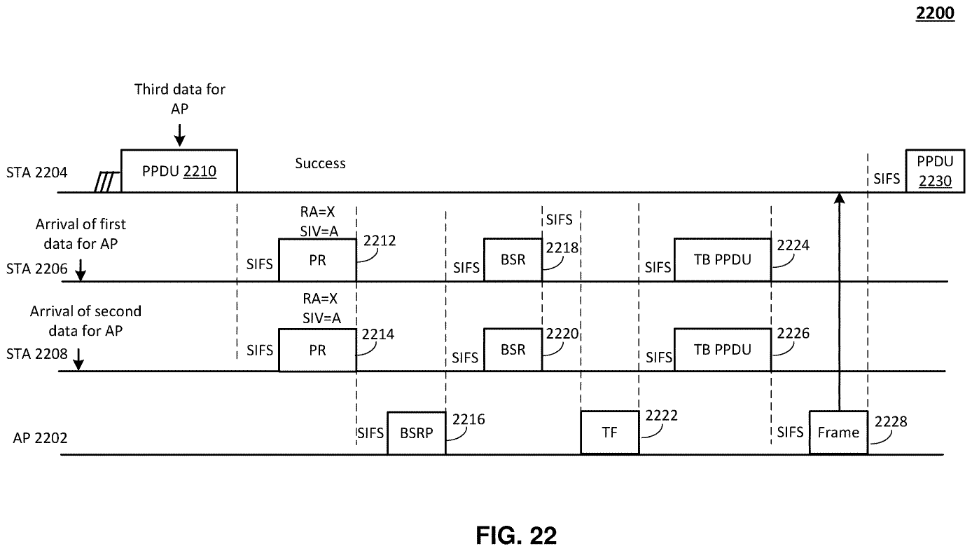

FIG. 22 is an example 2200 that illustrates another uplink preemption procedure according to an embodiment. As shown in FIG. 22, example 2000 may include an AP 2202 and STAs 2204, 2206, and 2208. STAs 2204, 2206, and 2208 may be associated with AP 2202.

In contrast to the example procedures described above in FIGS. 17-21 in which the preempted PPDU is to be transmitted by the AP (i.e., the AP is the TXOP holder), in example 2200, the preempted PPDU may be a PPDU to be transmitted by a STA (i.e., the TXOP holder is a non-AP STA). Specifically, as shown in FIG. 22, example 2200 may begin with STA 2204, as the TXOP holder, transmitting a PPDU 2210 to AP 2202 for example. Before or during the transmission of PPDU 2210, first data for AP 2202 may arrive at STA 2206 and second data for AP 2202 may arrive at STA 2208. In an example, both the first data and the second data may be low latency data that requires urgent transmission to AP 2202. In an implementation, PPDU 2210 may be one of multiple PPDUs being transmitted by STA 2204 to transmit third data to AP 2202. In an example, the third data may be non-low latency data. PPDU 2210 may include a preemption indication that indicates whether preemption of a next PPDU following PPDU 2210 is allowed.

In example 2200, the preemption indication of PPDU 2210 may be set to 1 indicating that preemption of the next PPDU is allowed. In an embodiment, the preemption indication may be provided in a PHY header (e.g., U-SIG or NG-SIG) of PPDU 2210, which improves the chance that both STAs 2206 and 2208 obtain the preemption indication. As such, based on the arrival of the first data and the second data respectively, STAs 2206 and 2208 may be configured to preempt a next PPDU (not shown in FIG. 22) from STA 2204 to AP 2202 to transmit respective PR frames 2212 and 2214 to AP 2202. In an implementation, PR frames 2212 and 2214 are transmitted a SIFS after an end of PPDU 2210 to preempt the next PPDU from STA 2204 to AP 2202.

In an implementation, PR frames 2212 and 2214 are transmitted concurrently and over the same channel. In an implementation, to ensure that the respective PPDUs carrying PR frames 2212 and 2214 are identical, the SIV part of the SERVICE field of the respective PPDUs (bits 0-6 of the SERVICE field after scrambling the DATA field of the respective PPDUs) and the RA of PR frames 2212 and 2214 may be set/generated as described in the embodiments above. For example, the SIV part of the SERVICE field of the respective PPDUs and the RA of PR frames 2212 and 2214 may be set/generated as described above in FIGS. 17, 18, 20, and 21. The respective PPDUs may thus be received successfully by AP 2202 and AP 2202 may respond to PR frames 2212 and 2214 by transmitting a BSRP frame 2216. BSRP frame 2216 may be transmitted a SIFS after an end of PR frames 2212 and 2214. BSRP frame 2216 solicits BSR frames from all STAs to allow AP 2202 to determine the STAs that have low latency traffic to transmit to AP 2202. In example 2200, as both STAs 2206 and 2208 have low latency traffic to transmit to AP 2202, STAs 2206 and 2208 may respond to BSRP frame 2216 with respective BSR frames 2218 and 2220. BSR frames 2218 and 2220 indicate to AP 2202 that STAs 2206 and 2208 have low latency traffic for AP 2202. BSR frames 2218 and 2220 may be transmitted a SIFS after an end of BSRP frame 2216. Subsequently, based on receiving BSR frames 2218 and 2220, AP 2202 may transmit a trigger frame 2222 to STAs 2206 and 2208. Trigger frame 2222 solicits TB uplink transmissions from STAs 2206 and 2208. Trigger frame 2222 may be transmitted a SIFS after an end of BSR frames 2218 and 2220. STAs 2206 and 2208 may respond to trigger frame 2222 by transmitting respective TB PPDUs 2224 and 2226 to AP 2202. PPDUs 2224 and 2226 may comprise the first data from STA 2206 and the second data from STA 2208 respectively. TB PPDUs 2224 and 2226 may be transmitted a SIFS after an end trigger frame 2222. In an example, TB PPDUs 2224 and 2226 may be transmitted over orthogonal frequency resources. Subsequently, AP 2202 may transmit a frame 2228 to STA 2204. Frame 2228 may be a trigger frame. Frame 2228 triggers STA 2204 to resume transmission of the third data. In response to frame 2228, STA 2204 may transmit a PPDU 2230 to AP 2202. PPDU 2230 may be transmitted a SIFS after an end of frame 2228. STA 2204 may thus regain control of its TXOP after being preempted by STAs 2206 and 2208 to transmit low latency data to AP 2202.

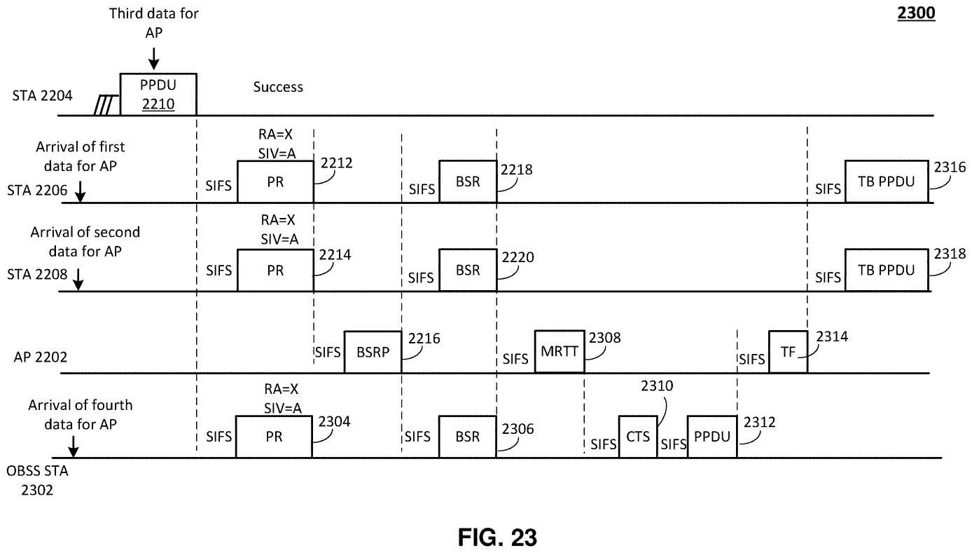

FIG. 23 is an example 2300 that illustrates another uplink preemption procedure according to an embodiment. Like example 2200 described above, example 1300 may also include AP 2202 and STAs 2204, 2206, and 2208. In addition, example 1300 may include an OBSS STA 2302. OBSS STA 2302 may be belong to a different BSS (OBSS) than the BSS of AP 2202 and STAs 2204, 2206, and 2208. OBSS STA 2302 may be an AP STA or a non-AP STA.

In example 1300, OBSS STA 2302 may have fourth data for AP 2202 arrive before or during the transmission of PPDU 2210 from STA 2204 to AP 2202. The fourth data may be low latency data that requires urgent transmission to AP 2202. In an implementation, as shown in FIG. 23, OBSS STA 2302 may operate in a similar manner as described above for STAs 2206 and 2208. Namely, OBSS STA 2302 may obtain the preemption indication of PPDU 2210, and, based on the preemption indication indicating that preemption is allowed, OBSS STA 2302 may transmit a PR frame 2304 to AP 2202.

In an implementation, PR frame 2304 is transmitted concurrently and over the same channel as PR frames 2212 and 2214. In an implementation, to ensure that the respective PPDUs carrying PR frames 2212, 2214, and 2304 are identical, the SIV part of the SERVICE field of the respective PPDUs (bits 0-6 of the SERVICE field after scrambling the DATA field of the respective PPDUs) and the RA of PR frames 2212, 2214, and 2304 may be set/generated as described in the embodiments above. For example, the SIV part of the SERVICE field of the respective PPDUs and the RA of PR frames 2212, 2214, and 2304 may be set/generated as described above in FIGS. 17 and 18, 20. The respective PPDUs may thus be received successfully by AP 2202 and AP 2202 may respond to PR frames 2212, 2214, and 2304 by transmitting a BSRP frame 2216. BSRP frame 2216 may be transmitted a SIFS after an end of PR frames 2212, 2214, and 2304. BSRP frame 2216 solicits BSR frames from all STAs to allow AP 2202 to determine the STAs that have low latency traffic to transmit to AP 2202. In example 2300, as each of STAs 2206, 2208, and OBSS STA 2302 have low latency traffic to transmit to AP 2202, STAs 2206 and 2208 and OBSS STA 2302 may respond to BSRP frame 2216 with respective BSR frames 2218, 2220, and 2306. BSR frames 2218, 2220, and 2306 indicate to AP 2202 that STAs 2206 and 2208 and OBSS STA 2302 have low latency traffic for AP 2202. BSR frames 2218, 2220, and 2306 may be transmitted a SIFS after an end of BSRP frame 2216.

Subsequently, in an embodiment, based on receiving BSR frame 2306 from OBSS STA 2302, AP 2202 may transmit a multi-user request-to-send (MU-RTS) TXOP sharing (TXS) trigger (MRTT) frame 2308 to OBSS STA 2302. MRTT frame 2308 may allocate to OBSS STA 2302 a time period to transmit the fourth data to AP 2202. In response to MRTT frame 2308, OBSS STA 2302 may transmit a CTS frame 2310 to AP 2202, followed by a PPDU 2312 to AP 2202. PPDU 2312 may comprise the fourth data for AP 2202. CTS frame 2310 may be transmitted a SIFS after an end of MRTT frame 2308. Similarly, PPDU 2312 may be transmitted a SIFS after an end of CTS frame 2310. AP 2202 may transmit a BA frame (not shown in FIG. 23) in response to PPDU 2312. Subsequently, AP 2202 may transmit a trigger frame 2314 to STAs 2206 and 2208 to allow them to transmit respectively the first data and the second data. Trigger frame 2314 may be transmitted a SIFS after an end of PPDU 2312 or the BA frame. STAs 2206 and 2208 may respond to trigger frame 2314 by transmitting respective TB PPDUs 2316 and 2318 to AP 2202. PPDUs 2316 and 2318 may comprise the first data from STA 2206 and the second data from STA 2208 respectively. TB PPDUs 2316 and 2318 may be transmitted a SIFS after an end trigger frame 2314. In an example, TB PPDUs 2316 and 2318 may be transmitted over orthogonal frequency resources. Subsequently, AP 2202 may transmit a frame to STA 2204 to resume transmission of the third data. STA 2204 may thus regain control of its TXOP after being preempted by OBSS STA 2302 and by STAs 2206 and 2208 to transmit low latency data to AP 2202.

In another embodiment (not shown in FIG. 23), AP 2202 may send trigger frame 2314 after receiving BSR frames 2218 and 2220 and 2306 to allow STAs 2206 and 2208 to transmit the first data and the second data to AP 2202, before transmitting MRTT frame 2308 to allow OBSS STA 2302 to transmit the fourth data to AP 2202.

In the above, embodiments have been described with reference to a preemption procedure that includes the transmission of PR frames. As would be understood by a person of skill in the art based on the teachings herein, embodiments are not limited to this example procedure. Indeed, more generally, embodiments may be applicable to any procedure in which a frame may be transmitted concurrently (and over the same frequency resources) by multiple STAs (requiring the identical frame to be transmitted by the multiple STAs) and where the content of one or more parts of the frame may be based on a previously received frame (which may not be properly decoded, partially or entirely, by one of the multiple STAs). For example, without limitation, embodiments may be equally applicable to an MU-RTS/CTS procedure as illustrated in FIG. 11 above.

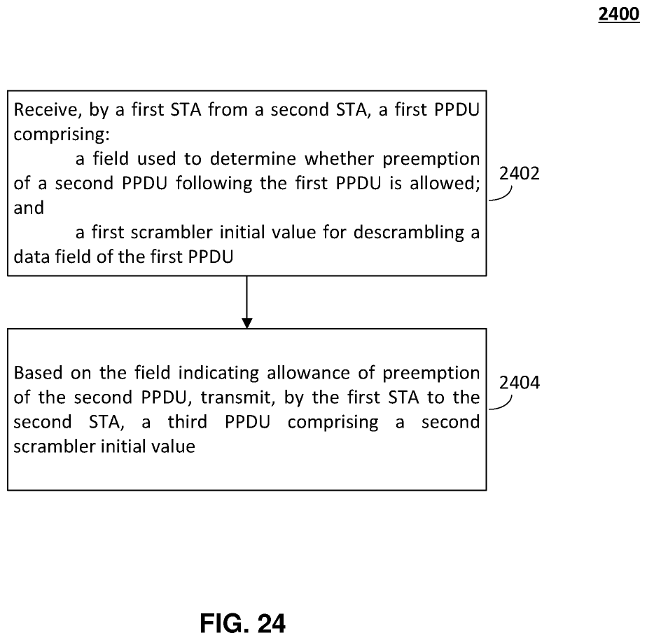

FIG. 24 illustrates an example process 2400 according to an embodiment. Example process 2400 may be performed by a first STA. The first STA may be a non-AP STA or an AP STA. For example, the first STA may correspond to STA 1704, 1706, 1804, 1806, 1904, 1906, 2004, 2006, 2104, and 2106. As shown in FIG. 24, process 2400 may include steps 2402 and 2404.

Step 2402 includes receiving, by the first STA from a second STA, a first PPDU. The second STA may be an AP STA or a non-AP STA. The first PPDU may comprise a field used to determine whether preemption of a second PPDU following the first PPDU is allowed. In an embodiment, the field may be provided in a PHY header of the first PPDU. In an embodiment, the first PPDU comprises a U-SIG or an NG-SIG (e.g., UHR-SIG). In an embodiment, the U-SIG or NG-SIG of the first PPDU comprises the field.

The first PPDU may further comprise a first scrambler initial value for descrambling a data field of the first PPDU. The first scrambler initial value may correspond to a SIV part of a SERVICE field of the first PPDU (bits 0-6 of the SERVICE field of the first PPDU before descrambling a DATA field of the first PPDU).

Step 2404 includes, based on the field indicating allowance of preemption of the second PPDU, transmitting, by the first STA to the second STA, a third PPDU. The third PPDU may be, without limitation, a CTS frame, a PR frame, or a low latency (LL) indication frame.

In an embodiment, the third PPDU comprises a second scrambler initial value. The second scrambler initial value may be different than the first scrambler initial value. In an embodiment, the second scrambler initial value comprises or corresponds to a SIV part (bits 0-6) of a SERVICE field of the third PPDU after scrambling a DATA field (comprising the SERVICE field) of the third PPDU. The second scrambler initial value may be used by a receiver to descramble a DATA field of the third PPDU.

In an embodiment, the U-SIG or the UHR-SIG of the first PPDU comprises the second scrambler initial value.

In another embodiment, the U-SIG or the UHR-SIG of the first PPDU comprises a plurality of fields, such as a Physical layer (PHY) Version Identifier field; a Basic Service Set (BSS) Color field; a Bandwidth field; an uplink/downlink (UL/DL) field; or a transmit opportunity (TXOP) field. In an embodiment, the first STA may determine the second scrambler initial value based on one or more of the plurality of fields.

In an embodiment, the data field of the first PPDU comprises one or more MPDU. In an embodiment, transmitting the third PPDU in step 2404 may be based on decoding at least one MPDU of the first PPDU. In such an embodiment, the second scrambler initial value may be based on the first scrambler initial value comprised in the first PPDU.

In an embodiment, process 2400 may further comprise receiving, by the first STA from an AP, a fourth PPDU. The first STA may be associated with the AP. In an embodiment, the fourth PPDU comprises the second scrambler initial value.

In another embodiment, the second scrambler initial value is a pre-defined value.

In an embodiment, the first STA is associated with a BSS. The second scrambler initial value may be based on a BSS color of the BSS or a BSSID of an AP of the BSS.

In another embodiment, the U-SIG or the UHR-SIG of the first PPDU comprises a receiver address of the third PPDU.

In another embodiment, the U-SIG or the UHR-SIG of the first PPDU comprises a plurality of fields, such as a Physical layer (PHY) Version Identifier field; a Basic Service Set (BSS) Color field; a Bandwidth field; an uplink/downlink (UL/DL) field; or a transmit opportunity (TXOP) field. In an embodiment, the first STA may determine the receiver address of the third PPDU based on one or more of the plurality of fields.

In another embodiment, transmitting the third PPDU in step 2404 may be further based on decoding at least one MPDU of the first PPDU. The receiver address of the third PPDU may be based on a transmitter address of the at least one MPDU.

In another embodiment, the fourth PPDU comprises a receiver address of the third PPDU.

In another embodiment, process 2400 may further comprise setting a receiver address of the third PPDU to a pre-defined value.

In an embodiment, the first STA is associated with a BSS. The receiver address of the third PPDU may be based on a BSS color of the BSS or a BSSID of an AP of the BSS.

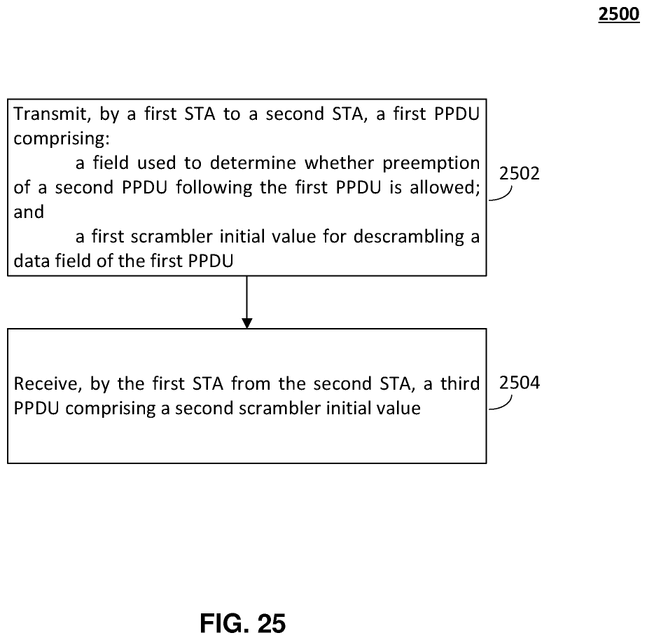

FIG. 25 illustrates another example process 2500 according to an embodiment. Example process 2500 may be performed by a first STA. The first STA may be a non-AP STA or an AP STA. For example, the first STA may correspond to AP 1702, AP 1802, AP 1902, AP 2002, AP 2102. As shown in FIG. 25, process 2500 may include steps 2502 and 2504.

Step 2502 includes transmitting, by the first STA to a second STA, a first PPDU. The second STA may be an AP STA or a non-AP STA. The first PPDU may comprise a field used to determine whether preemption of a second PPDU following the first PPDU is allowed. In an embodiment, the field may be provided in a PHY header of the first PPDU. In an embodiment, the first PPDU comprises a U-SIG or an NG-SIG (e.g., UHR-SIG). In an embodiment, the U-SIG or NG-SIG of the first PPDU comprises the field.

The first PPDU may further comprise a first scrambler initial value for descrambling a data field of the first PPDU. The first scrambler initial value may correspond to a SIV part of a SERVICE field of the first PPDU (bits 0-6 of the SERVICE field of the first PPDU after scrambling the DATA field of the first PPDU).

Step 2504 includes receiving, by the first STA from the second STA, a third PPDU. The third PPDU may be, without limitation, a CTS frame, a PR frame, or a low latency (LL) indication frame.

In an embodiment, the third PPDU comprises a second scrambler initial value. The second scrambler initial value may be different than the first scrambler initial value. In an embodiment, the second scrambler initial value comprises or corresponds to a SIV part (bits 0-6) of a SERVICE field of the third PPDU after scrambling a DATA field (comprising the SERVICE field) of the third PPDU. The second scrambler initial value may be used by a receiver to descramble a DATA field of the third PPDU.

In an embodiment, the U-SIG or the UHR-SIG of the first PPDU comprises the second scrambler initial value.

In another embodiment, the U-SIG or the UHR-SIG of the first PPDU comprises a plurality of fields, such as a Physical layer (PHY) Version Identifier field; a Basic Service Set (BSS) Color field; a Bandwidth field; an uplink/downlink (UL/DL) field; or a transmit opportunity (TXOP) field. In an embodiment, the second scrambler initial value may be based on one or more of the plurality of fields.

In an embodiment, the data field of the first PPDU comprises one or more MPDU. In an embodiment, receiving the third PPDU in step 2504 may be based on the second STA decoding at least one MPDU of the first PPDU. In such an embodiment, the second scrambler initial value may be based on the first scrambler initial value comprised in the first PPDU.

In an embodiment, process 2500 may further comprise transmitting, by the first STA, a fourth PPDU. In an embodiment, the fourth PPDU comprises the second scrambler initial value.

In another embodiment, the second scrambler initial value is a pre-defined value.

In another embodiment, the U-SIG or the UHR-SIG of the first PPDU comprises a receiver address of the third PPDU.

In another embodiment, the U-SIG or the UHR-SIG of the first PPDU comprises a plurality of fields, such as a Physical layer (PHY) Version Identifier field; a Basic Service Set (BSS) Color field; a Bandwidth field; an uplink/downlink (UL/DL) field; or a transmit opportunity (TXOP) field. In an embodiment, the receiver address of the third PPDU may be based on one or more of the plurality of fields.

In another embodiment, the fourth PPDU comprises a receiver address of the third PPDU. In another embodiment, the receiver address of the third PPDU may be set to a pre-defined value.

What is claimed is:

1. A first station (STA) comprising:
one or more processors; and
memory storing instructions, that when executed by the one or more processors, cause the first STA to:
receive, from a second STA, a first physical layer protocol data unit (PPDU) comprising a field used to determine whether preemption of a second PPDU following the first PPDU is allowed; and
based on the field indicating allowance of preemption of the second PPDU, transmit, to the second STA, a third PPDU comprising a first scrambler initial value, wherein the first scrambler initial value is a first pre-defined value.

2. The first STA of claim 1, wherein the first PPDU further comprises a second scrambler initial value for descrambling a data field of the first PPDU.

3. The first STA of claim 2, wherein the first scrambler initial value is different than the second scrambler initial value.

4. The first STA of claim 1, wherein the instructions, when executed by the one or more processors, further cause the first STA to receive, from the second STA, a fourth PPDU.

5. The first STA of claim 4, wherein the fourth PPDU comprises a receiver address of the third PPDU.

6. The first STA of claim 4, wherein the fourth PPDU comprises the first scrambler initial value.

7. The first STA of claim 1, further comprising setting a receiver address of the third PPDU to a second pre-defined value.

8. The first STA of claim 1, wherein the third PPDU comprises one of:
a clear to send (CTS) frame;
a preemption request (PR) frame; or
a low latency indication frame.

9. A first station (STA) comprising:
one or more processors; and
memory storing instructions, that when executed by the one or more processors, cause the first STA to:
transmit, to a second STA, a first physical layer protocol data unit (PPDU) comprising a field used to determine whether preemption of a second PPDU following the first PPDU is allowed; and
receive, from the second STA, a third PPDU transmitted using a first scrambler initial value, wherein, based on the field indicating allowance of preemption of the second PPDU, the first scrambler initial value is a first pre-defined value.

10. The first STA of claim 9, wherein the first PPDU further comprises a second scrambler initial value for descrambling a data field of the first PPDU.

11. The first STA of claim 10, wherein the first scrambler initial value is different than the second scrambler initial value.

12. The first STA of claim 9, wherein the instructions, when executed by the one or more processors, further cause the first STA to transmit a fourth PPDU.

13. The first STA of claim 12, wherein the fourth PPDU comprises a receiver address of the third PPDU.

14. The first STA of claim 12, wherein the fourth PPDU comprises the first scrambler initial value.

15. The first STA of claim 9, wherein the third PPDU comprises a receiver address, and wherein the receiver address is a second pre-defined value.

16. The first STA of claim 9, wherein the third PPDU comprises one of:
a clear to send (CTS) frame;
a preemption request (PR) frame; or
a low latency indication frame.

17. A non-transitory computer-readable medium comprising instructions that, when executed by one or more processors of a first station (STA), cause the first STA to:
receive, from a second STA, a first physical layer protocol data unit (PPDU) comprising a field used to determine whether preemption of a second PPDU following the first PPDU is allowed; and
based on the field indicating allowance of preemption of the second PPDU, transmit, to the second STA, a third PPDU comprising a first scrambler initial value, wherein the first scrambler initial value is a first pre-defined value.

18. The non-transitory computer-readable medium of claim 17, wherein the instructions, when executed by the one or more processors, further cause the first STA to set a receiver address of the third PPDU to a second pre-defined value.

19. The non-transitory computer-readable medium of claim 17, wherein the first PPDU further comprises a second scrambler initial value for descrambling a data field of the first PPDU.

20. The non-transitory computer-readable medium of claim 19, wherein the first scrambler initial value is different than the second scrambler initial value.
